(19) United States
(12) Patent Application Publication
(10) Pub. No.: US 2006/0286378 A1
(43) Pub. Date: Dec. 21, 2006

(54) Nanostructured composite particles and corresponding processes

(76) Inventors: Shivkumar Chiruvolu, San Jose, CA (US); Hui Du, Sunnyvale, CA (US); William E. McGovern, Lafayette, CA (US); Craig R. Horne, Sunnyvale, CA (US); Ronald J. Mosso, Fremont, CA (US); Nobuyuki Kambe, Menlo Park, CA (US)

Correspondence Address: DARDI & ASSOCIATES, PLLC, 220 S. 6TH ST., SUITE 2000, U.S. BANK PLAZA, MINNEAPOLIS, MN, 55402, US

(21) Appl. No.: 11/438,468

(22) Filed: May 22, 2006

Related U.S. Application Data
(60) Provisional application No. 60/683,650, filed on May 23, 2005.
(60) Provisional application No. 60/694,389, filed on Jun. 27, 2005.

(51) Int. Cl. B29B 9/00; B32B 5/16

(52) U.S. Cl. 428/402; 264/5; 264/7

(57) ABSTRACT

Collections of composite particles comprise inorganic particles and another composition, such as a polymer and/or a coating composition. In some embodiments, the composite particles have small average particle sizes, such as no more than about 10 microns or no more than about 2.5 microns. The composite particles can have selected particle architectures. The inorganic particles can have compositions selected for particular properties. The composite particles can be effective for printing applications, for the formation of optical coatings, and other desirable applications.

### CROSS REFERENCE TO RELATED APPLICATIONS

This patent application claims priority to copending U.S. Provisional Patent Application Ser. No. 60/683,650 filed on May 23, 2005 to Chiruvolu et al., entitled “Toners, Other Polymer-Inorganic Particle Composite Particles and Corresponding Processes,” and to copending U.S. Provisional Patent Application Ser. No. 60/694,389 filed on Jun. 27, 2005 to Chiruvolu et al., entitled “Toners, Other Polymer-Inorganic Particle Composite Particles and Corresponding Processes,” both of which are incorporated herein by reference.

### FIELD OF THE INVENTION

The invention relates to particulate composites formed from inorganic particles and polymers, such as organic polymers or inorganic polymers, having small average particle diameters, which in some embodiments can be no more than a micron. The invention further relates to processes for forming polymer-inorganic particle composite particles with desired properties. These materials and process can be used to form toner particles for electrophotography with desired size ranges.

### BACKGROUND OF THE INVENTION

Composites of inorganic particles and polymer can be materials that have properties relating to the individual materials or intermediate between the particular properties of the separate materials. Thus, desirable features can be incorporated in a single material through the formation of the composite. With suitable composites, material characteristics can be obtained that may be difficult or impossible to achieve with standard materials. In addition to the growing demands for materials with new properties, there is a trend toward the formation of smaller devices or other smaller structures. These size reductions impose further demands on material formation and/or processing.

Toner compositions can be used for electrophotography. Electrophotography is used generally for image production applications in printers, copiers, facsimile machines and the like. Dry toners generally involve a composite of several materials with a polymer base that flows upon heating during development of the toner onto the paper or other substrate surface. The material constraints on these composite toner particles introduce corresponding constraints to the toner particle formation process as well as the range of resulting toner properties.

### SUMMARY OF THE INVENTION

In a first aspect, the invention relates to a collection of composite particles having an average particle diameter no more than about 2.5 microns. In some embodiments, at least about 95 percent of the composite particles comprise a thermoplastic polymer and a plurality of inorganic particles. The collection of composite particles can form a dry powder. The particle diameter generally refers to a free flowing particle diameter or, in other words, diameters of particles that are not hard fused to each other such that the particles can be dispersed. The particles in general can have any shape, such as roughly spherical or rod shaped. The particles can have architectures and compositions as described further herein. The composites can further comprise one or more other compositions, such as pigments, phosphors, dyes, surface modifiers, charge modulators or the like. The composite particles can comprise inorganic particles comprising a semi-conducting material. In some embodiments, the composite particles comprise on average at least about 50 volume percent polymer binder. The inorganic particles can be essentially randomly distributed within the composite particle. The inorganic particles can have an average particle size of no more than about 250 nm. In further embodiments, at least about 90 percent of the composite particles have an aspect ratio of no more than about 1.8.

The inorganic particles can have a submicron average particle diameter. Inorganic particles are distinguishable from inorganic polymers in that inorganic particles have a three-dimensional, ordered, disordered or partially ordered structure in which the three-dimensional build up of the structure is a dominant characteristic. In contrast, an inorganic polymer has a significant two-dimensional or secondary structure even with significant amounts of crosslinking.

In a further aspect, the invention pertains to a collection of composite particles having an average particle size of not more than about 2.5 microns. In some embodiments, a majority of the composite particles have an inorganic particle core surrounded by the polymer binder, and the surface of the composite particles have a higher degree of crosslinking relative to the interior of the particles.

In another aspect, the invention pertains to a collection of composite particles comprising inorganic particles and a coating comprising an organic or silicon-based compound. The composite particles generally have an average particle size of no more than about 10 microns, and the inorganic particles generally have an average particle size of no more than about 100 nanometers. In some embodiments, the inorganic particles are phosphors, metal nitrides, metal carbides, metal sulfides, metalloid nitrides, metalloid carbides, metalloid sulfides, doped particles, combinations thereof or mixtures thereof.

In other aspects, the invention pertains to a collection of composite particles comprising inorganic particles and a polymer. A majority of the composite particles have a core comprising the polymer, and the inorganic particles are embedded along the surface of the composite particles. The collection of composite particles can be in a dry powder. The composite particles have an average particle size of no more than about 10 microns. The polymer can comprise a thermoplastic polymer binder. The inorganic particles can have an average particle size of no more than about 100 nm. In some embodiments, the collection of composite particles further comprise a polymer layer over the embedded inorganic particles.

Also, the invention pertains to a collection of composite particles having a layered structure with distinct compositions from each other. The composite particles comprise inorganic particles and a thermoplastic polymer binder. The composite particles have an average particle size of no more than about 10 microns, and each layer of the composite particles comprises a polymer.

In an additional aspect, the invention pertains to a collection of composite particles comprising inorganic particles and a multiple branched polymer, such as a dendrimer. In some embodiments, the composite particles have an average particle size of no more than about 2.5 microns. The collection of composite particles can be in a dry powder. The inorganic particles can be chemically bonded to the polymer. In some embodiments, a surface modifier can link the inorganic particles and the polymer in which the surface modifier is chemically bonded to the inorganic particles and the surface modifier is covalently bonded to the polymer.

In other aspects, the invention relates to a collection of particles in a dry powder comprising a polymer-inorganic particle composite having an average particle size no more than about 10 microns and the inorganic particles having a selected average particle diameter of no more than about 100 nm, wherein the inorganic particles have an appearance of a particular color upon exposure to light. The inorganic particles can have size dependent color, i.e., absorption, such that the average particle size is selected yield the desired color and the particle collection has a suitable narrow particle size distribution. Suitable inorganic particles can comprise metal nitride particles, such as particles comprising aluminum nitride or InₓGa₁₋ₓN, with 0≦x≦1, or doped metal nitride particles. Furthermore, the color can result from contrasts in index of refraction since interfaces between different index materials results in particular wavelengths of reflection, absorption and transmission. Thus, the embedding of high index-of-refraction inorganic particles in a lower index polymer can result in the observation of color.

Moreover, the invention pertains to a collection of composite particles comprising inorganic particles and an ordered polymer blend. The ordered polymer blend can comprise a block copolymer, a blend of immiscible polymers, a gradient in polymer crosslinking with depth in the particle, or the like.

Furthermore, the invention can pertain to a method for the formation of composite particles comprising inorganic particles and a polymer. The method comprises spray drying a solution comprising the inorganic particles and a polymer precursor. The polymer precursor can comprise, for example, polymerizable monomers, crosslinkable oligomers, a polymer solution or the like. Generally, the spray is reacted in-flight to form a thermoplastic polymer binder.

In further embodiments, the invention pertains to a printed structure comprising a substrate and images printed on the substrate. The images have an average thickness of no more than about three microns. The covers a selected portion of the surface of the substrate in which the selected portion is less than the entire substrate surface. The images may be black and/or a particular visible color due to the composite's absorption, reflection and transmission properties. The substrate can comprise, for example, paper. The image can be formed by printing the composite particles described herein. The image can comprise inorganic particles and a thermoplastic polymer binder.

In additional embodiments, the invention pertains to a method for forming a thin coating comprising a polymer-inorganic particle composite. The method comprises heating a substrate coated with a coating comprising composite particles. The composite particles comprise inorganic particles and a thermoplastic polymer. The heating can be performed to a temperature beyond the flow temperature of the polymer. The composite particles have an average particle diameter no more than about 2.5 microns. The corresponding composite coating can have an average thickness of no more than about 10 microns, in other embodiments no more than about 5 microns, and in further embodiments no more than about 3 microns. In some embodiments, the coating is printed to cover a portion of the substrate less than the entire substrate surface. The composite particles can further comprise a pigment, a phosphor or a dye. In additional or alternative embodiments, each of at least about 95 percent of the composite particles comprises a plurality of inorganic particles.

### BRIEF DESCRIPTION OF THE DRAWINGS

FIG. 1 is a schematic depiction of a composite particle with a single inorganic particle.

FIG. 2 is a schematic depiction of a composite particle with a plurality of randomly dispersed inorganic particles.

FIG. 3 is a schematic depiction of a layered composite particle.

FIG. 4 is a schematic depiction of a composite particle with a surface with embedded inorganic particles.

FIG. 5 is a schematic depiction of a composite particle formed with ordered block copolymers.

FIG. 6 is a flow diagram indicating a general framework for forming composite particles.

FIG. 7 is a flow diagram indicating some specific embodiments of processes to form composite particles.

FIG. 8 is a flow diagram indicating the process steps in an embodiment involving complete in-flight formation of composite particles.

FIG. 9 is a flow diagram outlining various embodiments involving a plurality of in-flight processing streams with inorganic and/or organic/polymer channels.

### DETAILED DESCRIPTION OF THE INVENTION

Improved composite particles in dry powder form can have reduced average particle diameters and/or improved particle structures, in which the particles comprise composites of polymer and inorganic particles. The polymers can be chemically bonded with the inorganic particles, or the polymer can otherwise function as a binder with respect to the inorganic particles, or the polymer can be physically adsorbed over the inorganic particles. Polymers can be organic or silicon-based polymers, and an ordered polymer can be useful to form more complex structures with desired properties. Improved processing approaches can be used efficiently to form desired materials. For example, in flight approaches can be used to modify particles following formation in a reactive stream. Also, aerosol approaches, such as spray drying, can be used to control particle formation in desirable ways to form composites with suitable properties. Composite particles with appropriate composition can be used as improved toners. The improved toner particles can be used to form sharper images with reduced amounts of material.

The composite particles generally comprise a polymer and inorganic particles in varying proportions selected as appropriate for the particular applications. Additional additives also can be incorporated into the particles. The polymer and inorganic particles can be randomly distributed within the particle, or the particles and polymer can be organized within a specific architecture that involves particular locations for the inorganic particles within the composite particles. In embodiments of particular interest, the composite particles have very small average particle sizes. Improved inorganic particle selection and processing approaches provide for formation of architectures and smaller particle sizes than were previously obtainable. In general, the average particle sizes can be less than 2.5 microns through the use of inorganic particles that can have submicron average particle sizes and extremely good dispersibility.

The composition of the composite particles can be selected for the particular application. For example, for toner particles, the inorganic particles can function as pigments, surface modifiers, reflectors, carriers and/or charge control agents. To act as surface modifiers, the inorganic particles can be concentrated along the surface of the particle. The polymer can function as a binder and can be selected to have a glass transition temperature suitable to have the polymer flow in response to appropriate temperatures. Similarly, the polymers should be stable at the temperature ranges to which the composite particles are subjected during use.

A range of polymers are suitable for incorporation into the composites, including both organic polymers and inorganic polymers, such as polysiloxanes. The polymers can be selected to have desired properties, such as the glass transition temperature T_{g} for amorphous polymers or the melting temperature Tₘ for crystalline polymer, which both correlate with the softening point of the polymer. Suitable polymers include block copolymers and polymer blends. Block copolymers can have compositions of the blocks such that the blocks order into separate phases. Thus, one block can associate with the inorganic particles while the other block segregates away from the inorganic particles. Immiscible polymer blends can function similarly to block copolymers that separate into different phases. The different blocks can have different physical properties, such as tackiness and/or T_{g}/Tₘ.

Dendrimers are highly branched polymer structures built upon a star-polymer. Dendrimers can be formed through the sequential reactions of polyfunctional monomers. The resulting structures are highly branched and can be formed with desired functional groups within the structure. Furthermore, dendrimer structures can be formed with structures that inherently form a shell with a core that can entrap small inorganic particles. Dendrimers are described further, for example, in U.S. Pat. No. 6,794,327 to Youngs et al., entitled Supramolecular Structures And Process For Making The Same,” and Published U.S. Patent Application 2003/0077635A1 to Lohse, entitled “Dendrimers and Methods For Their Preparation And use,” both of which are incorporated herein by reference.

The inorganic particles generally include metal or metalloid elements in their elemental form or in metal/metalloid compounds. Specifically, the inorganic particles can include, for example, elemental metal or elemental metalloid, i.e. un-ionized elements, metal/metalloid oxides, metal/metalloid nitrides, metal/metalloid carbides, metal/metalloid sulfides, metal/metalloid silicates, metal/metalloid phosphates or combinations thereof. As used herein, inorganic particles include elemental carbon particles, such as fullerenes, carbon black, carbon nanotubes, graphite and combinations thereof. Inorganic particles excluding carbon particles can be referred to as non-carbon inorganic particles, which comprise a metal and/or a metalloid. Metalloids are elements that exhibit chemical properties intermediate between or inclusive of metals and nonmetals. Metalloid elements include silicon, boron, arsenic, antimony, and tellurium. While phosphorous is located in the periodic table near the metal elements, it is not generally considered a metalloid element. However, P₂O₅ and doped forms of P₂O₅ are good optical materials similar to some metalloid oxides, and other optical materials doped with phosphorous, e.g., in the form of P₂O₅, can have desirable optical properties. For convenience, as used herein including in the claims, phosphorous is also considered a metalloid element.

The inorganic particles can be incorporated at a range of loadings into the blends. Particular loadings may be appropriate for specific applications. High inorganic particle loadings of up to about 50 weight percent or greater can be achieved with well dispersed particles. The composition of the components of the composite particles and the relative amounts of the components can be selected to yield desired properties in which the polymer functions as a binder. The inorganic particles can comprise a surface modifier that can facilitate dispersion or other functions. In some embodiments, the composite particles comprise mixtures of inorganic particles and polymers in which the polymer functions as a binder.

In other embodiments, the composite particles comprise polymer-inorganic particle composites with chemical bonding between the inorganic particles and the polymer, which may or may not involve a linker compound mediating the bonding of the polymer with the inorganic particle. A linker is a polyfunctional compound that binds with a first functional group with the inorganic particle and with a second functional group to the polymer. Chemical bonds, as used herein, generally has at least some covalent bond character and specific interactions, as distinguished from non-specific bonding, such as adhesive bonding, that involves a large number of weak, non-specific interactions and generally a significant entropic contribution. If the inorganic particles comprise a surface modifier, the surface modifier composition may or may not further function as a linker for bonding to the polymer. In addition, in embodiments involving chemically bonded composites, the amount of the linker compounds bonded to the inorganic particles can be adjusted to vary the degree of crosslinking obtained with the polymer.

In embodiments of the composite particles involving chemical bonding between the polymer and the inorganic particles, the polymer can be selected or modified to comprise appropriate functional groups to chemically bond with the inorganic particles or with functional groups of a linker compound. A linker compound can facilitate the formation of the resulting composite. Specifically, in these embodiments, the composites comprise a monomer/polymer component, inorganic particles, and linker compounds that bridge the inorganic particles and the monomer/polymer. In the case of monomer units being joined to the linker compound, a polymer is formed with the formation of the composite. For simplicity in notation, the monomer/polymer unit joined with the linker and assembled into the composite will be referred to generally as a polymer, although it is recognized that in some cases the unit can be a monomer or polymer, such as a dimer, trimer or larger polymer structures. The molecular weights of the polymers can be selected to vary the properties of the resulting composite.

In some embodiments, it may be advantageous to use collections of inorganic particles having an average diameter of less than about 500 nanometers (nm). Suitable nanoparticles can be formed, for example, by flame synthesis, combustion, micelle/reverse micelle, or sol gel approaches. Methods for synthesizing inorganic particles in commercial quantities with particular high uniformity include, for example, light-based pyrolysis/laser pyrolysis in which light from an intense electromagnetic radiation source drives the reaction to form the particles. For convenience, this application refers to light-based pyrolysis and laser pyrolysis interchangeably, since a suitable intense source of electromagnetic radiation can be used in place of a laser. Laser pyrolysis is useful in the formation of particles that are highly uniform in composition, crystallinity and size. Furthermore, inorganic particles can be effectively formed, for example, using laser pyrolysis that results in particles that have desirable surface properties that lead to high dispersibility and ready incorporation into desired composites, although other sources of particles can be used.

The use of nanoscale particles within the polymer/inorganic particle blends can impart improved and/or desired properties for some applications. In particular, nanoparticles can provide desirable optical performance due to desirable optical properties, such as generally decreased scattering relative to larger inorganic particles. High-quality nanoparticles are desirable for the generation of homogeneously mixed nanoparticle-polymer blends with well-defined optical properties. Specifically, it is desirable to have particles in which the primary particles are not highly agglomerated such that the primary particles can be dispersed effectively to form the composite. High-quality nanoparticles to form nanocomposites can be produced on a commercial scale, as described in U.S. Pat. No. 5,958,348 to Bi et al., entitled “Efficient Production of Particles By Chemical Reaction,” incorporated herein by reference.

In some embodiments, the composite particles can comprise inorganic particles, a polymer and optionally other one or more additives. While in general, the relative amounts of the components can be selected to be suitable for particular application. For some applications, such as toner applications, it can be desirable to have at least about 25 volume percent polymer, in further embodiments at least about 35 volume percent and in additional embodiments from about 40 to about 95 volume percent polymer, such that the polymer can help to fix the printed particles. Suitable additives can be property modifiers, such as waxes or antioxidants, or functional compositions, such as dyes. In general, the composite particles comprise no more than about 25 weight percent additives and in further embodiments no more than about 20 weight percent additives. Similarly, each additive is generally present in no more than about 15 weight percent and in other embodiments no more than about 10 weight percent. Inorganic particle compositions are discussed further above, and the remaining portion of the composite particles comprises the inorganic particles. A person of ordinary skill in the art will recognize that additional ranges of compositions within the explicit ranges above are contemplated and are within the present disclosure.

Since a wide range of inorganic particles and polymers can be incorporated into the composites described herein, the composites are suitable for a wide range of applications. For example, the composite particles can be used directly as free flowing particles or for the formation of coatings. In one application of interest, the particles are used as toner for application to a substrate surface using electrophotography and subsequently heated to bond the particles to the substrate surface. Toner applications are described herein in more detail, although all applications are contemplated for the improved composite particles. One significant advantage from the use of polymer-inorganic particle composites is the ability to control physical properties such as color, flow temperature, or electrical, magnetic or optical parameters over a wide range. A general discussion of polymer-inorganic particle composite compositions are described further U.S. Pat. No. 6,599,631 to Kambe et al., entitled “Polymer-Inorganic Particle Composites,” incorporated herein by reference and in copending U.S. patent application Ser. No. 10/083,967 to Kambe et al., entitled “Structures Incorporating Polymer-Inorganic Particle Blends,” incorporated herein by reference.

Generally, processing approaches for the formation of improved composite particles involve the effective dispersion of the inorganic particles. In some embodiments, the particles can be dispersed such that the secondary particle size, i.e., the effective particle size, is approximately equal to the primary particle size. The particles can be dispersed in the flow resulting in their formation or the particles can be dispersed following collection using a dispersant. It has been found that particles formed by laser pyrolysis can be well dispersed using organic dispersants, and thereby demonstrating that the primary particles are not hard fused, where the primary particle size and distribution of sizes are observed in a transmission electron micrograph. This is described further in U.S. Pat. No. 6,599,631 to Kambe et al., entitled “Polymer-Inorganic Particle Composites,” incorporated herein by reference. Formation of the polymer can be performed through combining the inorganic particles with monomers and subsequently polymerizing the monomers, or by combining the inorganic particles directly with the polymer generally in solution. If the inorganic particles are combined directly with a polymer, the composite can be further crosslinked subsequent to forming the combination.

In some embodiments of particular interest, the inorganic particles are formed in reactive flows in which a reactant stream comprising particle precursors is initiated by a reactant delivery system, the reactant stream is reacted at a reaction zone and the product particles subsequently flow in a product stream. For example, the reaction zone can correspond with a light reaction zone at or near the intersection of a light beam with a reactant flow or with a flame reaction zone. The product particles can be modified in-flight prior to collection. The in-flight modification of the particles can involve contact of the particles with a composition that can provide a surface modifier, a linker compound, monomer compounds and/or polymer compounds. The composition may or may not further comprise a solvent or a dispersant. In-flight modification and processing of inorganic particles is described further in copending and simultaneously filed U.S. patent application Ser. No. 11/______ to Chiruvolu et al., entitled “In-Flight Modification Of Inorganic Particles Within A Reaction Product Flow,” incorporated herein by reference.”

In some embodiments based on spray processing, composite formation solutions can be formed using an appropriate solvent/dispersant and subsequently subjected to an aerosol process to form composite particles within the spray. The polymer can be formed prior to the aerosol process and/or within the spray. Formation of the polymer within the spray can involve light induced polymerization, heat induced polymerization, polymerization that involves spontaneous reaction upon drying of the particles and/or reaction initiated with a catalyst that is introduced into the composite formation solution prior to, at the time of and/or subsequent to forming the aerosol. For example, the aerosol can be subjected to a UV light that initiates the polymerization process.

In some embodiments, conventional emulsion processes can be adapted for the production of improved materials. For example, pacifying inorganic particles can be deposited on the surfaces of suspended polymer particles to pacify the surface for subsequent drying. The surface can be pacified additionally or alternatively by crosslinking the outer surface of the toner particles. Similarly, the emulsion particles can be formed with a block copolymer with phase separated block having one phase along the composite particle surface and a second phase away from the composite particle surfaces. The outer polymer block can be crosslinked to pacify the surfaces of the composite particles for subsequent drying while leaving the inner blocks at a suitable melt temperatures for subsequent applications. Thus, for embodiments with pacification of the surfaces of the particles, undesirable agglomeration of the composite particles, as experienced in conventional processing, can be avoided upon drying from the emulsion. The dried particles can be milled to improve the flow properties of the dried powder.

In further embodiments, the polymers of the composite particles can be crosslinked following formation of the composite particles. Under sufficiently mild crosslinking conditions, the polymer at the surface of the particles may crosslink to a greater degree than the polymer deeper within the particles to provide a surface modification. Suitable crosslinking agents, such as chemical crosslinkers and radiation can be used to induce the crosslinking. The crosslinking can be performed in-flight if the composite particles are formed in-flight.

With respect to the formation of composite particles in-flight, the composite particles can comprise a single type of inorganic particles or a plurality of types of inorganic particles. Similarly, a separate organic assembly pathway can be used to form organic/polymer particles in-flight. In general, any of the composite particle architectures described herein can be formed with appropriate in-flight processes.

Processing of the organic particles in-flight can involve, for example, drying, crosslinking, polymerization, chemical modification, combinations thereof and the like. The polymer particles formed in-flight can be combined in-flight with inorganic particles formed in a reactive flow to form desired composite particles. Specifically, the flow from the organic reactive channel can be intersected with flow from the inorganic product flow to form the composites, in which the intersection can be performed within the inorganic particle reaction chamber or in a separate chamber. The inorganic particles in the product flow may or may not be modified in-flight prior to intersection with the organic product flows.

A range of composite particle architectures can be formed. In some embodiments, a majority of the composite particles comprise a single inorganic particle that is surrounded with a polymer material. The amount of polymer present correlates with the average thickness of the polymer coating over the particles, which can be selected as desired. In these embodiments, some of the particles, generally a small portion, in the composite may be inorganic particles alone and/or polymer particles free of inorganic particles.

In alternative embodiments, the inorganic particles are embedded generally randomly in a polymer matrix. The collection of particles has an average weight percent of polymer and inorganic particles, but the particular proportion in a composite particle can fluctuate around the average. The inorganic particles generally can be from a couple of nanometers in average diameter to roughly a micron or more in average diameter. If the particles are small enough, the composite particles on average can comprise a relatively large number of inorganic particles, such as on the order of tens of millions in contrast with the embodiments in which a single composite particle generally has a single inorganic particle.

In additional embodiments, the composite particles can have a core-shell structure. The embodiments with a single inorganic particle operating as a core with a shell of polymer can be considered one limit of such structures. In principle, there can be a plurality of layered shells with different compositions. More broadly, the core-shell structures can comprise one or more of differences between the core and shell(s) selected from different inorganic particles, different polymer compositions, different concentrations of inorganic particles, the presence or absence of inorganic particles, different additives, different degrees of crosslinking and/or the like. Generally, the core is formed first and subsequent shell layer(s) are sequentially added using the processing approaches described herein, such as in-flight processing, spray drying and the like or combinations thereof. However, in some embodiments, block copolymers or the like can be used to form a defacto core/shell structure if the blocks of the copolymer segregated into different phases. The inorganic particles can associate with one phase of the segregated copolymer.

In further embodiments, the composite particles can have a surface layer of small inorganic particles. Depending on the degree of wetting of the inorganic particle by the polymer the degree that the particles are exposed at the surface can vary. If the particles are well wetted, these structures can be effectively a shell over a core as described above. In general, the inorganic particle layer can pacify the surface and/or provide functionality to the surface. These surface coatings of particles can be formed by colliding polymer particles with a flow of particles or by coating the polymer particles with well-dispersed inorganic particles in solution, and drying or spray drying the dispersion. Alternatively or additionally, the inorganic particles can be chemically bonded to the polymer on the surface of the particles to form a composite with surface inorganic particles. The inorganic particle coating can be applied to polymer particles or onto particles that are themselves polymer-inorganic particle composites, such as any of the polymer-inorganic particle composite architectures described above.

The improved composite particles can be used effectively in a range of applications. For example, due to the small size and relative uniformity of the particles, they can be used to make very thin composite coatings. For example, spray coating of a dispersion of the particles onto a surface can result in a very thin and very uniform coating of the particles. Due the processability of the particles, the particle coating can achieve very uniform coating with a very thin layer. The particle coating can be heated above the T_{g} or Tₘ of the polymer to obtain a resulting very thin layer of composite. The layer thickness can be as thin as or less than the average particle diameter. For example, these coatings can be used as optical coatings with the inorganic particles being used to increase the index-of-refraction of the composite or to provide ultraviolet light blocking capability. Other coatings can provide scratch resistance.

In some embodiments of particular interest, the composite particles can be used as toner particles. Toner particles are deposited using electrophotography in which the particles are attracted to selectively charged portions of a surface. The toner particles can incorporate additional additives if desired, such as pigments, dyes, charge moderators, waxes and the like. The polymers or a portion thereof can be selected to have an appropriate melting temperature for a polymer particle. If the surface of the composite can be modified to be less tacky, such as through the coating with inorganic particles, selected crosslinking and/or a shell layer with a different polymer composition, the particles can be designed to melt or flow at lower temperatures such that a printed toner image can be developed onto the substrate surface at a lower temperature. In some embodiments, the particles have a low flow temperature as well as a non-tacky surface due to appropriate surface pacification approaches. Developing the image at a lower temperature correspondingly lowers the energy demands of the image production process and decreases unwanted side effects on the substrate from the heating process.

Composite Particle Structure, Architecture and Composition

The composite particles comprise inorganic particles and a polymer matrix such that the resulting composite particles incorporate aspects of both the inorganic particles and the polymer. The inorganic particles may or may not be chemically bonded to the polymer. The bonding of an inorganic particle to the polymer may or may not involve a linker that can be used to activate the surface of the inorganic particles for bonding with the polymer. Suitable composites can involve either low particle loadings or high particle loadings depending on the particular application. Similarly, the composition of the polymer component and the inorganic particle components can be selected to achieve desired properties of the resulting composite. The composite particles may exhibit a synergistic effect with respect to properties of the composite particles relative to those of the individual components. In some embodiments, the composites can comprise a plurality of different inorganic particles and/or a plurality of different polymers. Furthermore, the composite particles can comprise optional suitable additives that provide desired properties for processing and/or for use of the completed composite particles.

The inorganic particles can be incorporated at a range of loadings into the composite. Composites with low particle loadings can be produced with high uniformity if the inorganic particles are well dispersed. Low loadings, such as one or two weight percent or less, can be desirable for some applications. In addition, high inorganic particle loadings can be achieved with well-dispersed particles. In general, the inorganic particle loadings are from about 0.1 weight percent to about 90 weight percent, in other embodiments from about 1 weight percent to about 90 weight percent, in further embodiments from about 10 weight percent to about 85 weight percent, in additional embodiments from about 20 weight percent to about 85 weight percent and in some embodiments from about 30 to about 80 weight percent with respect to the composite particle weights. A person of skill in the art will recognize that other ranges within these explicit ranges are contemplated and are within the present disclosure. In addition, the amount the linker compounds bonded to the inorganic particles can be adjusted to vary the degree of crosslinking obtained with the polymer.

In some embodiments, a collection of composite particles have an average particle size of no more than about 10 microns. In further embodiments, collections of the composite particles can have an average particle diameter no more than about 2.5 microns, in further embodiments from about 4 nanometers (nm) to about 2.0 microns, in additional embodiments from about 5 nm to about 1.0 micron, in other embodiments from about 5 nm to about 500 nm and in additional embodiments from about 5 nm to about 250 nm, although for certain particle architectures and/or compositions it may be desirable to have larger particle diameters. A person of ordinary skill in the art will recognize that additional ranges of average particle diameters within the explicit ranges above are contemplated and are within the present disclosure. While certain particles can be roughly spherical in shape other particles can have other shapes. For non-spherical particles, the particle diameter can be obtained from an average of the distance across the particle along the three principle axes of the particle. Particle diameters are evaluated using transmission electron microscopy or scanning electron microscopy. Generally, the particles have high particle uniformity with respect to size and shape.

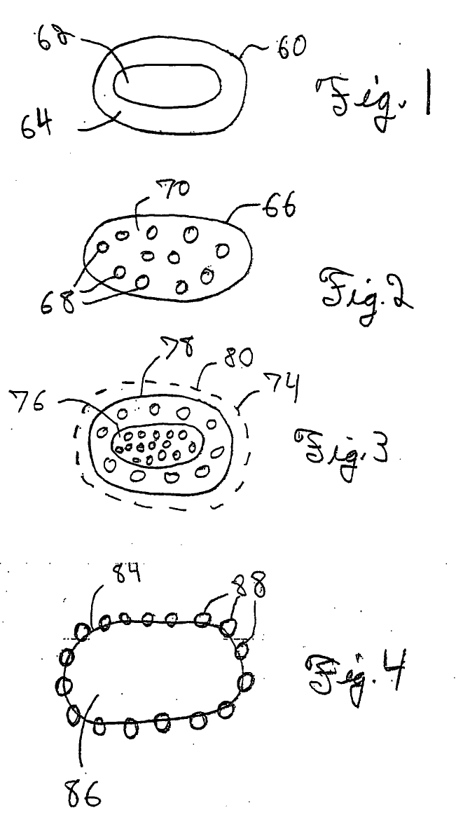

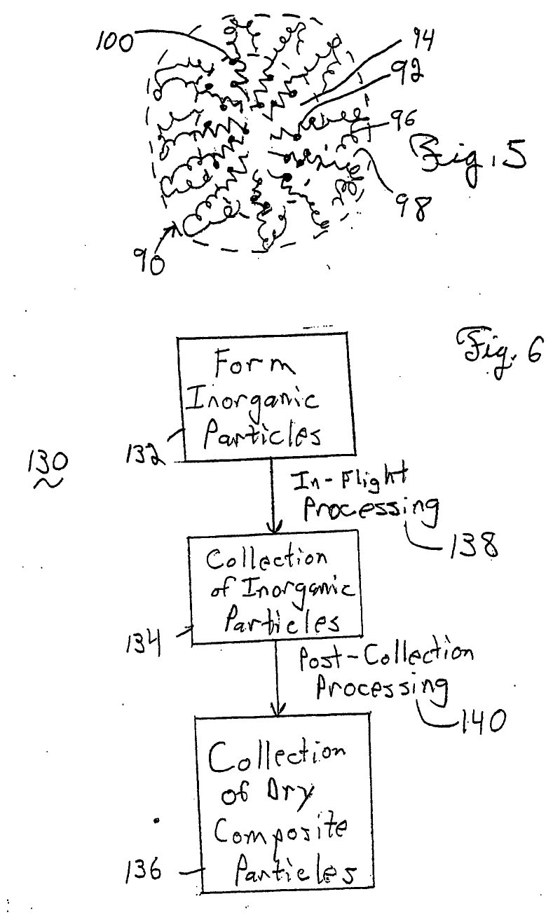

In general, the composite particles can have any reasonable architecture or combinations of architectures. Examples of composite particle morphology are given in FIGS. 1-4. Referring to FIG. 1, composite particle 60 comprises a single inorganic particle 62 and a polymer overcoat 64. Referring to FIG. 2, composite particle 66 comprises interspersed inorganic particles 68 and a polymer matrix 70. Inorganic particles 68 may or may not all have the same composition. In other words, the inorganic particles can comprise a blend of different compositions distributed within the polymer matrix. Similarly, the polymer matrix can comprise a single polymer or a blend of different polymers. The particles can be essentially randomly dispersed or there may be some alignment due to interactions within the materials, for example is the particles were magnetic or if the polymer tended to impose a structure on the composite.

If the composite particles generally comprise a plurality of inorganic particles, there generally will be a distribution of numbers of inorganic particle within the composite particles. In some embodiments, a majority of the composite particles have a plurality of inorganic particles and in further embodiments at least about 95 percent of the composite particles have a plurality of inorganic particles. In some embodiments, essentially all of the composite particles have a plurality of inorganic particles. A person of ordinary skill in the art will recognize that additional ranges of composite particle composition within the explicit ranges above are contemplated and are within the present disclosure.

Referring to FIG. 3, composite particle 74 comprises a core shell structure with a core 76, a first shell 78 and an optional second shell 80, although additional optional shells can also be present. While core 76, first shell 78 and second shell 80 have different compositions from each other, the composition can vary between them in a range of ways, such as different inorganic particles based on particle composition or particle dimensions, different polymer compositions, different loadings of inorganic particles, presence or absence of inorganic particles, different additive compositions, combinations thereof and the like. If the polymers in different portions of the composite are the same or somewhat miscible with other, the precise boundary between the core and shell and/or between different shells may or may not only be specified on average, and may be inferred approximately from the production approach if no direct measure of the structure is available. One core shell structure of particular interest involves particles that have an outer shell comprising a crosslinked polymer.

The proportion of the particle volume attributed to the core and/or a specific shell may be selected as desired, although generally the core diameter and or layer thickness is generally at least about 1 nm. However, in some embodiments, the composition may have a gradient roughly as a function of radius. These structures would correspond to essentially continuously changing shells, although atomic sizes provide a physical limit to the gradient in shell structure/composition. For example, the crosslinking density can be a function of the radial distance if mild crosslinking conditions crosslink from the exterior surface inward and the crosslinking is limited such that there is greater crosslinking toward the surface of the particles.

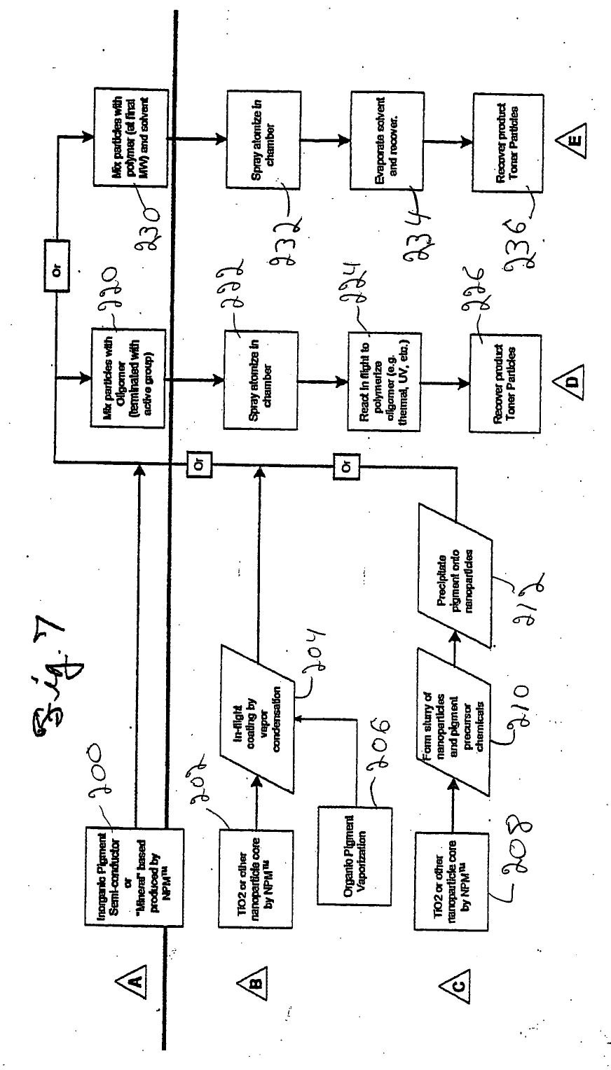

Referring to FIG. 4, composite particle 84 comprises an inner particle 86 and surface embedded inorganic particles 88. Inner particle 86 may or may not include other or the same inorganic particles. If inner particle 86 comprises inorganic particles, inner particle 86 can have any of the structures shown in FIGS. 1-3. Inorganic particles 88 are embedded along the surface of inner particle 86, and the polymer of inner particle 86 holds inorganic particle 86 on the surface. The degree in which the surface particles are embedded generally can depend on the surface properties of the particles, the composition of the polymer and the method for forming the composite particles. In some embodiments, it is desirable for the embedded inorganic particles to have an average secondary particle diameter of no more than about 250 nm, in further embodiments no more than about 100 nm and in further embodiments from about 2 nm to about 50 nm. Overlayers can be placed over the particles with structures as shown in FIG. 4, such as a polymer layer.

Toner particles can be coated with inorganic particles or coated inorganic particles. Forming coatings with fumed silica are described further in U.S. Pat. Nos. 6,190,815 and 6,004,714 both to Ciccarelli et al., entitled “Toner Compositions,” both of which are incorporated herein by reference. In contrast with these approaches, Applicants describe herein using substantially unagglomerated inorganic particles, such as silica. While silica can be suitable as a surface coating, a range of other inorganic particles can be desirable as surface coatings. In particular, the surface coating inorganic particles can have an average secondary particle size of no more than about 100 nm, and in further embodiments from about 2 nm to about 50 nm. In addition, the inorganic particles can have the uniformity described herein. A person of ordinary skill in the art will recognize that additional ranges of average secondary particle size are contemplated and are within the present disclosure.

Polymers and inorganic particle constituents of the composite particles are described further in the following sections. Depending on the application, it may be desirable to incorporate one or more additional additives into the particles. The amount of additive can be selected based on the type of additive and the particular application. In general, these other additives can be, for example, pigments, dyes, viscosity modifiers, surfactants, such as cationic, anionic and nonionic surfactants, waxes, softening agents, crosslinking agents, catalysts, charge retention agents, charge control agents, anti-oxidants, other processing aids, suitable combinations thereof and the like. For forming toner particles, it may be particularly desirable to have a dye or pigment for forming a color toner. The inorganic particles can function as a pigment, or an organic or inorganic pigment/dye can be used.

Suitable dyes and pigments are generally known in the art. In some embodiments, the composite particles comprise from about 0.1 weight percent pigment to about 50 weight percent pigment and/or dye, and in further embodiments from about 0.5 weight percent pigment and/or dye to about 40 weight percent pigment and/or dye. A person of ordinary skill in the art will recognize that additional ranges of pigment and/or dye concentrations within the explicit ranges are contemplated and are within the present disclosure. With respect to black pigments, suitable pigments include, for example, pigments known in the art, such as carbon black and magnetites, generally iron oxides. Commercially available magnetites include, for example, MO8029 and MO8060 from Mapico, Inc., St. Louis, Mo., Pfizer magnetites (CB4799, CB5300, CB5600, MCX6369), Bayer magnetites (BAYFERROX™ 8600, 8610), Northern Pigments magnetites (NP-604, NP-608), Magnox magnetities (TMB-100, TMB-104).

Desired pigments/dyes for color application are generally primary colors cyan, magenta, yellow or combinations thereof For example, suitable dyes and pigments include, for example, 2,9-dimethyl substituted quinacridone and anthraquinone dyes, copper tetra(octadecyl sulfonamido) phthalocyanine, x-copper phthalocyanine pigment (color index CI 74160), diarylide yellow 3,3-dichlorobenzidene acetoacetanilides (CI 12700), 2,5-dimethoxy-4-sulfonamide phenylazo-4′-chloro-2,5-dimethoxy acetoacentanilide as well as pigments from Paul Uhlich & Co., Inc. (HELIOGEN BLUE™ L6900, D7080, D7020, PYLAM OIL BLUE™, PYLAM OIL YELLLOW™, PIGMENT BLUE 1™), Dominion Color Corp., Ltd., Toronto, Ontario Canada (Pigment Violet 1, Pigment Red 48, Lemon Chrome Yellow DDC 1026™, E. D. TOLUIDINE RED™, BON RED C™), Hoechst (NOVAPERM YELLOW FGL™, HOSTAPERM PINK E™) and DuPont (CINQUASIA MAGENTA™). The formation of submicron solid organic pigment particles is described further in U.S. Pat. No. 6,749,980 to Cheng et al., entitled “Toner Processes,” incorporated herein by reference.

Toner particles can comprise charge additives, generally in the amount from 0.1 to about 5 weight percent. In the embodiments described herein, the inorganic particles may function as a charge additive, such that other charge additives may not be needed. Suitable additional charge additives include, for example, charge additives known in the art, such as alkyl pyridinium halides, bisulfates, distearyl dimethyl ammonium methyl sulfate, behenyl trimethyl ammonium methyl sulfate, alkyldimethylbenzyl ammonium salts, 4-azo-1-azoniabicyclo (2.2.2) octane salts and alkoxylated amines. Charge additives are described further in U.S. Pat. No. 4,560,635 to Hoffend et al., entitled “Toner Compositions With Ammonium Sulfate Charge Enhancing Additives,” incorporated herein by reference.

Waxes can be incorporated into a toner particle generally in amounts no more than about 10 weight percent. Suitable waxes include waxes known in the art such as waxes and wax emulsions available from Allied Chemical (polypropylenes, polyethylenes, chlorinated polypropylenes and polyethylenes and mixtures thereof), Petrolite Corp. (polypropylenes, polyethylenes, chlorinated polypropylenes and polyethylenes and mixtures thereof), Michaelman Inc., Daniels Product Co., Eastman Chemical Products, Inc. (EPOLENE N-15™). Sanyo Kasei K. K (VISCOL 55-P™ a low average molecular weight polypropylene), Micro Powder Inc. (AQUA SUPERSLIP™ 6550 and 6530, functionalized waxes and fluorinated waxes POLYFLUO™ 190, 200, 523XF, AQUA POLYFLUO™ 411, AQUA POLYSILK™ 19, POLYSILK™ 14, mixed fluorinated and functionalized waxes MICROSPERSION 19™), and S. C. Johnson Wax (functionalized acrylic polymer emulsions JONCRYL™ 74, 89, 130, 537, and 538). Other suitable waxes include, for example, solid paraffin wax, rice wax, amide wax, fatty acid wax, fatty acid metallic salt wax, fatty ester wax, partially-saponified fatty ester wax, silicon wax and carnauba wax.

Inorganic Particles

In general, any reasonable inorganic particles can be used to form the composites. In some embodiments, the particles have an average diameter of no more than about one micron. The composition of the particles generally is selected to impart desired properties to the composite. Thus, in the formation of toners for example, the color and electrical properties of the inorganic particles can be significant.

Small and uniform inorganic particles can provide processing advantages with respect to forming small and uniform composite particles. In addition, small inorganic particles have desirable properties for optical applications including, for example, a shifted absorption spectrum and reduced scattering. Suitable nanoparticles can be formed, for example, by laser pyrolysis, flame synthesis, combustion, or sol gel approaches. In particular, laser pyrolysis is useful in the formation of particles that are highly uniform in composition, crystallinity and size. Laser pyrolysis involves light from an intense light source that drives the reaction to form the particles. Laser pyrolysis is an excellent approach for efficiently producing a wide range of nanoscale particles with a selected composition and a narrow distribution of average particle diameters. Alternatively, submicron particles can be produced using a flame production apparatus such as the apparatus described in U.S. Pat. No. 5,447,708 to Helble et al., entitled “Apparatus for Producing Nanoscale Ceramic Particles,” incorporated herein by reference. Furthermore, submicron particles can be produced with a thermal reaction chamber such as the apparatus described in U.S. Pat. No. 4,842,832 to Inoue et al., “Ultrafine Spherical Particles of Metal Oxide and a Method for the Production Thereof,” incorporated herein by reference. In addition, various solution-based approaches can be used to produce some compositions of submicron particles, such as sol gel techniques.

Highly uniform particles can be formed by light-based pyrolysis, e.g., laser pyrolysis, which can be used to form submicron particles with extremely uniform properties with a variety of selectable compositions. For convenience, light-based pyrolysis is referred to as laser pyrolysis since this terminology reflects the convenience of lasers as a radiation source and is a conventional term in the art. Laser pyrolysis approaches discussed herein incorporate a reactant flow that can involve gases, vapors, aerosols or combinations thereof to introduce desired elements into the flow stream. The versatility of generating a reactant stream with gases, vapor and/or aerosol precursors provides for the generation of particles with a wide range of potential compositions.

A collection of submicron/nanoscale particles may have an average diameter for the primary particles of less than about 500 nm, preferably from about 2 nm to about 100 nm, alternatively from about 2 nm to about 75 nm, or from about 2 nm to about 50 nm. A person of ordinary skill in the art will recognize that other ranges within these specific ranges are covered by the disclosure herein. Particle diameters are evaluated by transmission electron microscopy.

Particles refer to physical particles, which are unfused, so that any fused primary particles are considered as an aggregate, i.e. a physical particle. As noted more below, the particles are generally effectively the same as the primary particles, i.e., the primary structural element within the material. If there is hard fusing of some primary particles, these hard fused particles form secondary physical particles. The secondary particles, if any are present, are physical particles for the consideration of particle size. The particles can have a roughly spherical gross appearance, or they can have rod shapes, plate shapes or other non-spherical shapes. Upon closer examination, crystalline particles generally have facets corresponding to the underlying crystal lattice. Amorphous particles generally have a spherical aspect. Diameter measurements on particles with asymmetries are based on an average of length measurements along the principle axes of the particle.

Because of their small size, the particles tend to form loose agglomerates due to van der Waals and other electromagnetic forces between nearby particles. These loose agglomerates can be dispersed in a dispersant to a significant degree based on the primary particles, and in some embodiments approximately completely to form dispersed primary particles. The size of the dispersed particles can be referred to as the secondary particle size. The primary particle size, of course, is the lower limit of the secondary particle size for a particular collection of particles, so that the average secondary particle size preferably is approximately the average primary particle size. The secondary or agglomerated particle size may depend on the subsequent processing of the particles following their initial formation and the composition and structure of the particles. In some embodiments, the secondary particles have an average diameter no more than about 1000 nm, in additional embodiments no more than about 500 nm, in further embodiments from about 2 nm to about 300 nm, in other embodiments about 2 nm to about 100 nm, and alternatively about 2 nm to about 50 nm. A person of ordinary skill in the art will recognize that other ranges within these specific ranges are contemplated and are within the present disclosure. Secondary particles sizes within a liquid dispersion can be measured by established approaches, such as dynamic light scattering. Suitable particle size analyzers include, for example, a Microtrac UPA instrument from Honeywell based on dynamic light scattering, a Horiba Particle Size Analyzer from Horiba, Japan and ZetaSizer Series of instruments from Malvern based on Photon Correlation Spectroscopy. The principles of dynamic light scattering for particle size measurements in liquids are well established.

Even though the particles may form loose agglomerates, the nanometer scale of the particles is clearly observable in transmission electron micrographs of the particles. The particles generally have a surface area corresponding to particles on a nanometer scale as observed in the micrographs. Furthermore, the particles can manifest unique properties due to their small size and large surface area per weight of material. For example, the absorption spectrum of crystalline, nanoscale TiO₂ particles is shifted into the ultraviolet.

The particles can have a high degree of uniformity in size. Laser pyrolysis generally results in particles having a very narrow range of particle diameters. Furthermore, heat processing under suitably mild conditions generally does not significantly alter the very narrow range of particle diameters. With aerosol delivery of reactants for laser pyrolysis, the distribution of particle diameters is particularly sensitive to the reaction conditions. Nevertheless, if the reaction conditions are properly controlled, a very narrow distribution of particle diameters can be obtained with an aerosol delivery system. As determined from examination of transmission electron micrographs, the particles generally have a distribution in sizes such that at least about 95 percent, and in some embodiments 99 percent, of the particles have a diameter greater than about 40 percent of the average diameter and less than about 160 percent of the average diameter. In embodiments of particular interest, the particles have a distribution of diameters such that at least about 95 percent, and in some embodiments 99 percent, of the particles have a diameter greater than about 60 percent of the average diameter and less than about 140 percent of the average diameter. A person of ordinary skill in the art will recognize that other ranges of uniformity within these specific ranges are covered by the disclosure herein.

Furthermore, in some embodiments no particles have an average diameter greater than about 5 times the average diameter, in other embodiments about 4 times the average diameter, in further embodiments 3 times the average diameter, and in additional embodiments 2 times the average diameter. In other words, the particle size distribution effectively does not have a tail indicative of a small number of particles with significantly larger sizes. This is a result of the small reaction region to form the inorganic particles and corresponding rapid quench of the inorganic particles. An effective cut off in the tail of the size distribution indicates that there are less than about 1 particle in 10⁶ have a diameter greater than a specified cut off value above the average diameter. High particle uniformity can be exploited in a variety of applications.

In addition, the nanoparticles for incorporation into the composite particles may have a very high purity level. Furthermore, crystalline nanoparticles, such as those produced by laser pyrolysis, can have a high degree of crystallinity. Similarly, the crystalline nanoparticles produced by laser pyrolysis can be subsequently heat processed to improve and/or modify the degree of crystallinity and/or the particular crystal structure. Impurities on the surface of the particles may be removed by heating the particles to achieve not only high crystalline purity but high purity overall.

A basic feature of successful application of laser pyrolysis for the production of desirable inorganic nanoparticles is the generation of a reactant stream containing one or more metal/metalloid precursor compounds, a radiation absorber and, in some embodiments, a secondary reactant. The secondary reactant can be a source of non-metal/metalloid atoms, such as oxygen, required for the desired product and/or can be an oxidizing or reducing agent to drive a desired product formation. A secondary reactant may not be used if the precursor decomposes to the desired product under intense light radiation. Similarly, a separate radiation absorber may not be used if the metal/metalloid precursor and/or the secondary reactant absorb the appropriate light radiation. The reaction of the reactant stream is driven by an intense radiation beam, such as a light beam, e.g., a laser beam. As the reactant stream leaves the radiation beam, the inorganic particles are rapidly quenched.

A laser pyrolysis apparatus suitable for the production of commercial quantities of particles by laser pyrolysis has been developed using a reactant inlet that is significantly elongated in a direction along the path of the laser beam. This high capacity laser pyrolysis apparatus, e.g., 1 kilogram or more per hour, is described in U.S. Pat. No. 5,958,348, entitled “Efficient Production Of Particles By Chemical Reaction,” incorporated herein by reference. Approaches for the delivery of aerosol precursors for commercial production of particles by laser pyrolysis is described in copending and commonly assigned U.S. Pat. No. 6,193,936 to Gardner et al., entitled “Reactant Delivery Apparatus,” incorporated herein by reference.

In general, nanoparticles produced by laser pyrolysis can be subjected to additional processing to alter the nature of the particles, such as the composition and/or the crystallinity. For example, the nanoparticles can be subjected to heat processing in a gas atmosphere prior to use. Under suitably mild conditions, heat processing is effective to modify the characteristics of the particles without destroying the nanoscale size or the narrow particle size distribution of the initial particles. For example, heat processing of submicron vanadium oxide particles is described in U.S. Pat. No. 5,989,514 to Bi et al., entitled “Processing Of Vanadium Oxide Particles With Heat,” incorporated herein by reference.

A wide range of simple and complex submicron and/or nanoscale particles have been produced by laser pyrolysis with or without additional heat processing. In general, the inorganic particles generally include metal or metalloid elements in their elemental form or in compounds. Specifically, the inorganic particles can include, for example, elemental metal or elemental metalloid, i.e. un-ionized elements such as silver or silicon, metal/metalloid oxides, metal/metalloid nitrides, metal/metalloid carbides, metal/metalloid sulfides or combinations thereof In addition, there is the capability for producing nano-particulate carbon materials. Complex systems of ternary and quaternary compounds have also been made. In addition, uniformity of these high quality materials can be substantial. These particles generally can have a very narrow particle size distribution. Availability of a wide range of compositions and crystal structures of nanoparticles provides a corresponding significant range in potential combinations between nanoparticles and polymers as well as properties for the resulting composites.

With respect to the electrical properties of the particles, some particles include compositions such that the particles are electrical conducting, electrical insulators or electrical semiconductors. Suitable electrical conductors include, for example, elemental metals and some metal compositions. Electrical conductors, such as metals, generally have a room temperature resistivity of no more than about 1×10⁻³ Ohm-cm. Electrical insulators generally have a room temperature resistivity of at least about 1×10⁵ Ohm-cm. Electrical semiconductors include, for example, silicon, GaN, CdS and InP. Semiconducting crystals can be classified to include so called, II-VI compounds, III-V compounds and group IV compounds, where the number refers to the group in the periodic table. Semiconductors are characterized by a large increase in conductivity with temperature in pure form and an increase in electrical conductivity by orders of magnitude upon doping with electrically active impurities. Semiconductors generally have a band gap that results in the observed conductivity behavior. At room temperature, the conductivity of a semiconductor is generally between that of a metal and a good electrical insulator.

Several different types of nanoscale particles have been produced by laser pyrolysis. Elemental carbon particles generally may or may not be considered inorganic materials. As used herein, carbon particles as carbonaceous solids, such as fullerenes, nanotubes, graphite, and carbon black are not considered inorganic particles and are considered distinguishable from both inorganic materials and organic materials for clear separate identification. Selected inorganic particles can generally be characterized as comprising a composition with a number of different elements that are present in varying relative proportions, where the number and the relative proportions are selected based on the application for the nanoscale particles. Materials that have been produced (possibly with additional processing, such as a heat treatment) or have been described in detail for production by laser pyrolysis include, for example, carbon particles, silicon, SiO₂, doped SiO₂, titanium oxide (anatase and rutile TiO₂), MnO, Mn₂O₃, Mn₃O₄, Mn₅O₈, vanadium oxide, silver vanadium oxide, lithium manganese oxide, aluminum oxide (γ-Al₂O₃, delta-Al₂O₃ and theta-Al₂O₃), doped-aluminum oxide (alumina), tin oxide, zinc oxide, rare earth metal oxide particles, rare earth doped metal/metalloid nitride particles, rare earth metal/metalloid sulfides, rare earth doped metal/metalloid sulfides, silver metal, iron, iron oxide, iron carbide, iron sulfide (Fe₁₋ₓS), cerium oxide, zirconium oxide, barium titanate (BaTiO₃), aluminum silicate, aluminum titanate, silicon carbide, silicon nitride, and metal/metalloid compounds with complex anions, for example, phosphates, silicates and sulfates. The production of a range of particles by laser pyrolysis is described further in copending U.S. patent application Ser. No. 10/195,851 to Bi et al., entitled “Nanoparticle Production and Corresponding Structures,” incorporated herein by reference.

Submicron and nanoscale particles can be produced with selected dopants using laser pyrolysis and other flowing reactor systems. Amorphous powders and crystalline powders can be formed with complex compositions comprising a plurality of selected dopants. The powders can be used to form optical materials and the like. Amorphous submicron and nanoscale powders and glass layers with dopants, such as rare earth dopants and/or other metal dopants, are described further in copending and commonly assigned U.S. Pat. No. 6,849,334 to Home et al., entitled “Optical Materials And Optical Devices,” incorporated herein by reference. Crystalline submicron and nanoscale particles with dopants, such as rare earth dopants, are described further in copending and commonly assigned U.S. patent application Ser. No. 09/843,195 to Kumar et al., entitled “High Luminescence Phosphor Particles,” incorporated herein by reference.

The dopants can be introduced at desired quantities by varying the composition of the reactant stream. The dopants are introduced into an appropriate host material by appropriately selecting the composition in the reactant stream and the processing conditions. Thus, submicron particles incorporating one or more metal or metalloid elements as host composition with selected dopants, including, for example, rare earth dopants and/or complex blends of dopant compositions, can be formed. For embodiments in which the host materials are oxides, an oxygen source should also be present in the reactant stream. For these embodiments, the conditions in the reactor should be sufficiently oxidizing to produce the oxide materials.

Furthermore, dopants can be introduced to vary properties of the resulting particles. For example, dopants can be introduced to change the optical properties of the particles that are subsequently incorporated into polymer-inorganic particle composite particles. For optical applications, the index-of-refraction can be varied to form specific optical devices that operate with light of a selected frequency range or dopants can introduce fluorescent or phosphorescent properties to the particles such that they can function as phosphors. Dopants can also be introduced to alter the processing properties of the material. Furthermore, dopants can also interact within the materials. For example, some dopants are introduced to increase the solubility of other dopants.

In some embodiments, the one or plurality of dopants are rare earth metals or rare earth metals with one or more other dopant elements. Rare earth metals comprise the transition metals of the group IIIb of the periodic table. Specifically, the rare earth elements comprise Sc, Y and the Lanthanide series. Other suitable dopants comprise elements of the actinide series. For optical glasses, the rare earth metals of particular interest as dopants comprise, for example, Ho, Eu, Ce, Tb, Dy, Er, Yb, Nd, La, Y, Pr and Tm. Generally, the rare earth ions of interest have a +3 ionization state, although Eu⁺² and Ce⁺⁴ are also of interest. Rare earth dopants can influence the optical absorption properties that can alter the application of the materials for the production of optical amplifiers and other optical devices. Suitable non-rare earth dopants for various purposes include, for example, Bi, Sb, Zr, Pb, Li, Na, K, Ba, B, Si, Ge, W, Ca, Cr, Ga, Al, Mg, Sr, Zn, Ti, Ta, Nb, Mo, Th, Cd and Sn.

As noted above, laser pyrolysis has been used to produce a range of powder compositions. The compositions can include multiple metal/metalloid elements. A representative sample of references relating to some of these powder materials is presented in the following.

As a first example of nanoparticle production, the production of silicon oxide nanoparticles is described in copending and commonly assigned U.S. patent application Ser. No. 09/085,514 to Kumar et al., entitled “Silicon Oxide Particles,” incorporated herein by reference. This patent application describes the production of amorphous SiO₂. The synthesis by laser pyrolysis of silicon carbide and silicon nitride is described in copending and commonly assigned U.S. patent application Ser. No. 09/433,202 to Reitz et al. filed on Nov. 5, 1999, entitled “Particle Dispersions,” incorporated herein by reference. The production of silicon particles by laser pyrolysis is described in an article by Cannon et al., J. of the American Ceramic Society, Vol. 65, No. 7, pp. 330-335 (1982), entitled Sinterable Ceramic Particles From Laser-Driven Reactions: II, Powder Characteristics And Process Variables,” incorporated herein by reference.

The production of titanium oxide nanoparticles and crystalline silicon dioxide nanoparticles is described in copending and commonly assigned, U.S. patent application Ser. No. 09/123,255 to Bi et al., entitled “Metal (Silicon) Oxide/Carbon Composites,” incorporated herein by reference. In particular, this application describes the production of anatase and rutile TiO₂. The production of aluminum oxide nanoparticles is described in copending and commonly assigned, U.S. patent application Ser. No. 09/136,483 to Kumar et al., entitled “Aluminum Oxide Particles,” incorporated herein by reference. In particular, this application disclosed the production of γ-Al₂O₃. Suitable liquid, aluminum precursors with sufficient vapor pressure of gaseous delivery include, for example, aluminum s-butoxide (Al(OC₄H₉)₃). Also, a number of suitable solid, aluminum precursor compounds are available including, for example, aluminum chloride (AlCl₃), aluminum ethoxide (Al(OC₂H₅)₃), and aluminum isopropoxide (Al[OCH(CH₃)₂]₃).

Furthermore, mixed metal nitride nanoparticles have been produced by laser pyrolysis along with or without subsequent heat processing, as described in copending and commonly assigned U.S. patent applications Ser. No. 09/188,768 to Kumar et al., entitled “Composite Metal Oxide Particles,” and Ser. No. 09/334,203 to Kumar et al., entitled “Reaction Methods for Producing Ternary Particles,” and U.S. Pat. No. 6,136,287 to Home et al., entitled “Lithium Manganese Oxides and Batteries,” all three of which are incorporated herein by reference. The formation of submicron and nanoscale particles comprising metal/metalloid compounds with complex anions is described in copending and commonly assigned U.S. patent application Ser. No. 09/845,985 to Chaloner-Gill et al., entitled “Phosphate Powder Compositions And Methods For Forming Particles With Complex Anions,” incorporated herein by reference. Suitable complex anions include, for example, phosphates, silicates and sulfates.

As noted above, the inorganic particles can function as pigments, either black or a specific color, charge control agents and/or surface modifiers. Suitable charge control agents and/or surface modifiers include, for example, SiO₂, TiO₂ and Al₂O₃. Suitable colorants include, for example, doped compounds, including doped phosphor compositions. Phosphor compositions that can be used as colorants are described further, for example, in U.S. Pat. No. 6,692,660 to Kumar et al., entitled “High Luminescent Phorphor Particles,” incorporated herein by reference. Also, quantum confined particles can be used as colorants in which quantum confined particles has very small and uniform particle diameters with a controlled particle size such that the inorganic particle size itself determines the color of the particles. Quantum confined particles of CdS and CdSe are described in U.S. Pat. No. 5,505,928 to Alivisatos et al., entitled “Preparation of III-V Semiconductor Nanocrystals,” incorporated herein by reference.

Furthermore, the composition of mixed metal oxides can be varied to select the color of the resulting inorganic particles. InₓGa₁₋ₓN is one mixed metal composition of particular interest. These particles can be formed using laser pyrolysis. Suitable precursors of In include, for example, indium trichloride, and suitable precursors for Ga include, for example, gallium metal, organometallic gallium, gallium oxide, and/or gallium trifluoride. The nitride can be formed using laser pyrolysis using a nitrogen precursor, such as ammonia, in the absence of oxygen atoms. The band gap of the semiconductor is a function of the value of x, i.e., the ration of In to Ga. The value of x of the particles can be selected through the selection of the amounts of the metal precursors in the reactive flow. For example, In_{0.1}Ga_{0.9}N yields a material with a violet color while In_{0.4}Ga_{0.6}N yields a material with a red color.

Polymers and Internal Material Structure

As noted above, the polymer-inorganic particle composites may or may not involve chemical bonding between the inorganic particles and the polymers. Chemical bonding is considered to broadly cover bonding with some covalent character with or without partial ionic bonding character and can have properties of ligand-metal bonding. Covalent bonding refers broadly to covalent bonds with sigma bonds, pi bonds, other delocalized covalent bonds and/or other covalent bonding types, and may be polarized bonds with or without ionic bonding components and the like. In other embodiments, the inorganic particles are simply embedded within the polymer matrix by the physical properties of the matrix. For convenience, blends not involving chemical bonding between the inorganic particles and the polymer matrix are called polymer-inorganic particle mixtures, while blends having chemical bonding between at least a portion of the inorganic particles and the polymer are called bonded composites. Of course, polymer-inorganic particle mixtures generally involve non-bonding electrostatic interactions, such as van der Waals interactions, between the polymer and the inorganic particles.

While mixtures are suitable in many contexts, the formation of polymer-inorganic particle bonded composites can have advantages with respect to stability and uniformity of the blend. Specifically, high particle loadings can be achieved in a bonded composite without significant agglomeration of the particles, provided that the particles are functionalized with groups that do not easily bond to themselves, which can result in the formation of hard agglomerates. In addition, in relevant embodiments, the amount the linker compounds bonded to the inorganic particles can be adjusted to vary the degree of crosslinking obtained with the polymer.

The composites with bonding between the polymer and the inorganic particles comprise a monomer/polymer component, inorganic particles, and optional linker compounds that bridge the inorganic particles and the monomer/polymer. In the case of monomer units being joined to the linker compound, a polymer can be formed with the formation of the composite. For simplicity in notation, the monomer/polymer unit joined with the linker and assembled into the composite can be referred to generally as a polymer, although it is recognized that in some cases the unit can be a monomer or polymer, such as a dimer, trimer or larger polymer structures.

The linker compounds have two or more functional groups. One functional group of the linker is suitable for chemical bonding to the inorganic particles. One functional group can be selected based on the composition of the inorganic particle. Another functional group of the linker is suitable for covalent bonding with the polymer. Convenient linkers include, for example, functionalized organic molecules.

Various structures can be formed based on embodiments involving the formation of chemically bonded polymer/inorganic particle composites. The structures obtained will generally depend on the relative amounts of polymer/monomers, linkers and inorganic particles as well as the synthesis process itself. Linkers may be identified also as coupling agents or crosslinkers. Furthermore, in some embodiments, polymer-inorganic particle bonded composites, as well as polymer-inorganic particle mixtures, can comprise a plurality of different polymers and/or a plurality of different inorganic particles. Similarly, if a poly-inorganic particle blend comprises a plurality of different polymer and/or a plurality of different inorganic particles, all of the polymer and/or inorganic particles can be chemically bonded within the composite or, alternatively, only a fraction of the polymers and inorganic particles can be chemically bonded within the composite. If only a fraction of the polymer and/or inorganic particles are chemically bonded, the fraction bonded can be a random portion or a specific fraction of the total polymer and/or inorganic particles.

To form the desired bonded composites, the inorganic particles can be modified on their surface by chemical bonding to one or more linker molecules. The ratio of linker composition to inorganic particles can be at least one linker molecule per inorganic particle. The linker molecules surface modify the inorganic particles, i.e., functionalize the inorganic particles. While the linker molecules can bond to the inorganic particles, they can be, but are not necessarily, bonded to the inorganic particles prior to bonding to the polymers. They can be bonded first to the polymers and only then bonded to the particles. Alternatively, they can bond to the two species simultaneously. Similarly, the inorganic particles can be surface modified with compositions that interact, and generally chemically bond, with the surface of the inorganic particles but do not have functional groups that bond with the polymer. However, surface modification alone can be useful to aid with dispersion and/or to provide other processing advantages.

In some embodiments, the linker is applied to form at least a significant fraction of a monolayer on the surface of the particles. In particular, for example, at least about 20% of a monolayer can be applied to the particles, and in other embodiments, at least about 40% of a monolayer can be applied. Based on the measured BET surface areas of the particles, a quantity of linker can be used corresponding up to coverage about ½, 1 and 2 of the particle surface relative to a monolayer of the linker. A person of ordinary skill in the art will recognize that other ranges within these explicit ranges are contemplated and are within the present disclosure. A monolayer is calculated based on measured surface area of the particles and an estimate of the molecular radius of the linker based on accepted values of the atomic radii. Excess linker reagent can be added because not all of the linker binds and some self-polymerization of the linker reagent can take place. To calculate the coverage, the linker can be assumed to bond to the particle normal to the surface. This calculation provides an estimate of the coverage.

The inorganic particles can be bonded through the linker compound into the polymer structure, or the particles can be grafted to polymer side groups. The bonded inorganic particles can, in most embodiments, crosslink the polymer. Specifically, most embodiments involve star crosslinking of a single inorganic particle with several polymer groups. The structure of the composite can generally be controlled by the density of linkers, the length of the linkers, the chemical reactivity of the coupling reaction, the density of the reactive groups on the polymer as well as the loading of particles and the molecular weight range of the polymer (i.e., monomer/polymer units). In alternative embodiments, the polymer has functional groups that bond directly with the inorganic particles, either at terminal sites or at side groups. In these alternative embodiments, the polymer includes functional groups comparable to appropriate linker functional groups for bonding to the inorganic particles.

A range of polymers is suitable for incorporation into the composites, including, without limitation, organic polymers, inorganic polymers, such as polysiloxanes, and combinations and copolymers thereof If the polymers are formed prior to reacting with the functionalized inorganic particles, the molecular weights of the polymers can be selected to vary to properties of the resulting composite. The polymer is selected or synthesized to include appropriate functional groups to covalently bond with functional groups of the linker compound.

The frame of the linker supporting the functional groups is generally an organic compound, although it may also include silyl and/or siloxy moieties. The organic linker frame can comprise any reasonable organic moiety including, for example, linear or branched carbon chains, cyclical carbon moieties, saturated carbon moieties, unsaturated carbon moieties, aromatic carbon units, halogenated carbon groups and combinations thereof. The structure of the linker can be selected to yield desirable properties of the composite. For example, the size of the linker is a control parameter that may affect the periodicity of the composite and the self-organization properties.

Many different types of polymers are suitable for incorporation into the composites. In bonded composite embodiments, the polymers generally can have terminal groups and/or side groups capable of bonding to a linker or directly to the inorganic particles. Whether or not the polymers are chemically bonded to the inorganic particles, suitable organic polymers include, for example, polyamides (nylons), polyimides, polycarbonates, polyurethanes, polyacrylonitrile, polyacrylic acid, polyacrylates, polyacrylamides, polyvinyl alcohol, polyvinyl chloride, heterocyclic polymers, polyesters, modified polyolefins and copolymers and mixtures thereof Composites formed with nylon polymers, i.e., polyamides, and inorganic nanoparticles can be called Nanonylon™. Suitable polymers include conjugated polymers within the polymer backbone, such as polyacetylene, and aromatic polymers within the polymer backbone, such as poly(p-phenylene), poly(phenylene vinylene), polyaniline, polythiophene, poly(phenylene sulfide), polypyrrole and copolymers and derivatives thereof Some polymers can be bonded to linkers at functional side groups. The polymer can inherently include desired functional groups, can be chemically modified to introduce desired functional groups or copolymerized with monomer units to introduce portions of desired functional groups. Similarly, some composites include only a single polymer/monomer composition bonded into the composite. Within a crosslinked structure, a polymer is identifiable by 3 or more repeat units along a chain, except for hydrocarbon chains which are not considered polymers unless they have a repeating side group or at least about 50 carbons—carbon bonds within the chain.

Suitable silicon-based polymers include polysilanes, polysiloxane (silicone) polymers, such as poly(dimethylsiloxane) (PDMS) and copolymers and mixtures thereof as well as copolymers and mixtures with organic polymers. Polysiloxanes are particularly suitable for forming composites with grafted inorganic particles. To form these grafted composites, the polysiloxanes can be modified with amino and/or carboxylic acid groups. Polysiloxanes are desirable polymers because of their transparency to visible and ultraviolet light, high thermal stability, resistance to oxidative degradation and its hydrophobicity. Other inorganic polymers include, for example, phosphazene polymers (phosphonitrile polymers).

Appropriate functional groups for binding with the polymer depend on the functionality of the polymer. Generally, the functional groups of the polymers and the linker can be selected appropriately based on known bonding properties. For example, carboxylic acid groups bond covalently to thiols, amines (primary amines and secondary amines) and alcohol groups. As a particular example, nylons can include unreacted carboxylic acid groups, amine groups or derivatives thereof that are suitable form covalently bonding to linkers. In addition, for bonding to acrylic polymers, a portion of the polymer can be formed from acrylic acid or derivatives thereof such that the carboxylic acid of the acrylic acid can bond with amines (primary amines and secondary amines), alcohols or thiols of a linker. The functional groups of the linker can provide selective linkage either to only particles with particular compositions and/or polymers with particular functional groups. Other suitable functional groups for the linker include, for example, halogens, silyl groups (—SiR₃₋ₓHₓ), isocyanate, cyanate, thiocyanate, epoxy, vinyl silyls, silyl hydrides, silyl halogens, mono-, di- and trihaloorganosilane, phosphonates, organometalic carboxylates, vinyl groups, allyl groups and generally any unsaturated carbon groups (—R′—C═C—R″), where R′ and R″ are any groups that bond within this structure. Selective linkage can be useful in forming composite structures that exhibit self-organization.

Upon reaction of the polymer functional groups with the linker functional groups, the identity of initial functional groups is merged into a resultant or product functional group in the bonded structure. A linkage is formed that extends from the polymer. The linkage extending from the polymer can include, for example, an organic moiety, a siloxy moiety, a sulfide moiety, a sulphonate moiety, a phosphonate moiety, an amine moiety, a carbonyl moiety, a hydroxyl moiety, or a combination thereof The identity of the original functional groups may or may not be apparent depending on the resulting functional group. The resulting functional groups generally can be, for example, an ester group, an amide group, an acid anhydride group, an ether group, a sulfide group, a disulfide group, an alkoxy group, a hydrocarbyl group, a urethane group, an amine group, an organo silane group, a hydridosilane group, a silane group, an oxysilane group, a phosphonate group, a sulphonate group or a combination thereof.

If a linker compound is used, one resulting functional group generally is formed where the polymer bonds to the linker and a second resulting functional group is formed where the linker bonds to the inorganic particle. At the inorganic particle, the identification of the functional group may depend on whether particular atoms are associated with the particle or with the functional group. One or more atoms of the inorganic particle are involved in forming the bond between the linker and the inorganic particle. It may be ambiguous if an atom in the resulting linkage originates from the linker compound or the inorganic particle. This is just a nomenclature issue, and a person of skill in the art can identify the resulting structures without concern about the particular allocation of atoms to the functional group. In any case, a resulting or product functional group is formed joining the linker molecule and the inorganic particle. The resulting functional group can be, for example, one of the functional groups described above resulting from the bonding of the linker to the polymer. As a specific example, the bonding of a carboxylic acid with an inorganic particle may result in a group involving bonding with a non-metal/metalloid atom of the particle; however, an oxo group is generally present in the resulting functional group regardless of the composition of the particle. Ultimately, a bond extends to a metal/metalloid atom.

Appropriate functional groups for bonding to the inorganic particles depends on the character of the inorganic particles. U.S. Pat. No. 5,494,949 to Kinkel et al., entitled “SURFACE-MODIFIED OXIDE PARTICLES AND THEIR USE AS FILLERS AND MODIFYING AGENTS IN POLYMER MATERIALS,” incorporated herein by reference, describes the use of silylating agents for bonding to metal/metalloid oxide particles. The particles have alkoxy modified silane for bonding to the particles. For example, preferred linkers for bonding to metal/metalloid oxide particles include R¹R²R³—Si—R⁴, where R¹, R², R³ are alkoxy groups, which can hydrolyze and bond with the particles, and R⁴ is a group suitable for bonding to the polymer. Trichlorosilicate (—SiCl₃) functional groups can react with an hydroxyl group at the metal oxide particle surface by way of a condensation reaction.

Generally, thiol groups can be used to bind to metal sulfide particles and certain metal particles, such as gold, silver, cadmium and zinc. Carboxyl groups can bind to other metal particles, such as aluminum, titanium, zirconium, lanthanum and actinium. Similarly, amines and hydroxide groups would be expected to bind with metal oxide particles and metal nitride particles, as well as to transition metal atoms, such as iron, cobalt, palladium and platinum.

In some embodiments, the polymer incorporates the inorganic particles into the polymer network. This can be performed by reacting a functional group of the linker compound with terminal groups of a polymer molecule. Alternatively, the inorganic particles can be present during the polymerization process such that the functionalized inorganic particles are directly incorporated into the polymer structure as it is formed. In other embodiments, the inorganic particles are grafted onto the polymer by reacting the linker functional groups with functional groups on polymer side groups. In any of these embodiments, the surface modified/functionalized inorganic particles can crosslink the polymer if there are sufficient linker molecules, i.e., enough to overcome energetic barriers and form at least two or more bonded links to the polymer. Generally, an inorganic particle has many linkers associated with the particle. Thus, in practice, the crosslinking depends on the polymer-particle arrangement, statistical interaction of two crosslinking groups combined with molecular dynamics and chemical kinetics.

Block copolymers can be used such that the different blocks of the polymer segregate, which is a conventional property of selected block copolymers. Suitable block copolymers include, for example, polystyrene-block-poly(methyl methacrylate), polystyrene-block-polyacrylamide, polysiloxane-block-polyacrylate and mixtures thereof. These block copolymers can be modified to include appropriate functional groups to bond with the linkers, if desired. For example, polyacrylates can be hydrolyzed or partly hydrolyzed to form carboxylic acid groups, or acrylic acid moieties can be substituted for all or part of the acrylated during polymer formation if the acid groups do not interfere with the polymerization. Alternatively, the ester groups in the acrylates can be substituted with ester bonds to diols or amide bonds with diamines such that one of the functional groups remains for bonding with a linker. Block copolymers with other numbers of blocks and other types of polymer compositions can be used.

The inorganic particles can be associated with only one of the polymer compositions within the block such that the inorganic particles are segregated together with that polymer composition within the segregation block copolymer. For example, an AB di-block copolymer can include inorganic particles only within block A. Segregation of the inorganic particles can have functional advantages with respect to taking advantage of the properties of the inorganic particles. Similarly, tethered inorganic particles may separate relative to the polymer by analogy to different blocks of a block copolymer if the inorganic particles and the corresponding polymers have different solvation properties. In addition, the nanoparticles themselves can segregate relative to the polymer to form a self-organized structure. The block copolymers can have more than two blocks, such as ABC or ABA triblock copolymers.

The segregation of different polymer blocks can result in self-organization within the composite particles. For example, the segregated layers can result in a functional core-shell structure. A schematic diagram of a segregated block copolymer composite within a composite particle 90 is shown in FIG. 5. For illustration, a first polymer block 92 within core 94 is depicted with sharp bend, while a second polymer block 96 within shell 98 is depicted with curves. In this embodiment, inorganic particles 100 are depicted in association with first polymer block 92, although other configurations can be found in other embodiments. For example, the inorganic particles can be associated with the second polymer block in the shell, or the same or different inorganic particles can be associated with both blocks. The structure in FIG. 5 has some analogies with the structure in FIG. 3. Dashed lines schematically indicate a rough separation of core 94 from shell 98 and other exterior surface of composite particle 90.

Other ordered copolymers include, for example, graft copolymers, comb copolymers, star-block copolymers, dendrimers, mixtures thereof and the like. Ordered copolymers of all types can be considered a polymer blend in which the polymer constituents are chemically bonded to each other. Dendrimers in particular can have advantageous structures for the formation of composite particles. Specifically, dendrimers are highly branched polymers that can form structures with cavities that can hold inorganic particles. Dendrimers can be functionalized as appropriate.

Physical polymer combinations may also be used and may also exhibit self-organization. Polymer combinations involve mixtures of chemically distinct polymers. The polymers can segregate into a core-shell structure as shown in FIG. 3. The inorganic particles may bond to only a subset of the polymer species, as described above for block copolymers. Physical polymer combinations can exhibit self-organization similar to block copolymers. The presence of the inorganic particles can sufficiently modify the properties of the composite that the interaction of the polymer with inorganic particles interacts physically with the other polymer species differently than the native polymer alone. In particular, the presence of nanoparticles within the polymer-inorganic particle blends can result in a blend that is sensitive to weak fields due to the small particle size. This sensitivity can be advantageously used in the formation of devices. Processes making use of small particles generally can be referred to as a soft matter approach.

Exemplary embodiments of polymer-inorganic particle composites are described further in copending and commonly assigned U.S. Pat. No. 6,599,631 to Kambe et al., entitled “Polymer-Inorganic Particle Composites,” incorporated herein by reference, and copending U.S. patent application Ser. No. 10/083,967 to Kambe et al., entitled “Structures Incorporating Polymer-Inorganic Particle Blends,” incorporated herein by reference.

Processing to Form Composite Particles

In some embodiments, inorganic particles from an appropriate source or synthesis approach are incorporated into a process for the formation of the composite material, which can involve more than one processing step. In further embodiments, the inorganic particles are synthesized in a flow based process, and one or more aspects of the further processing are incorporated into an in-flight processing of the inorganic particles prior to their collection. In some embodiments, the entire process can be completed in-flight such that the first material collected comprises composite particles with inorganic particles and a polymer. Also, there can be an in-flight organic composition/droplet processing channel prior to association with inorganic particles, which is also generally in-flight. Alternatively, other processing approaches can be based on flow-based methods such as spray drying or the like, to form composite particles from a dispersion/solution comprising inorganic particles and polymers and/or polymer precursors. Other composite particle synthesis approaches can be based on reactions within a solution/dispersion, such as emulsion synthesis approaches. In general, it may be desirable to pacify the surface of the composite particles, chemically or physically through separation at the point of drying, at the last stage of the process such that the formation of the composite particles involves the formation of free flowing composite particles without significant hard agglomeration.

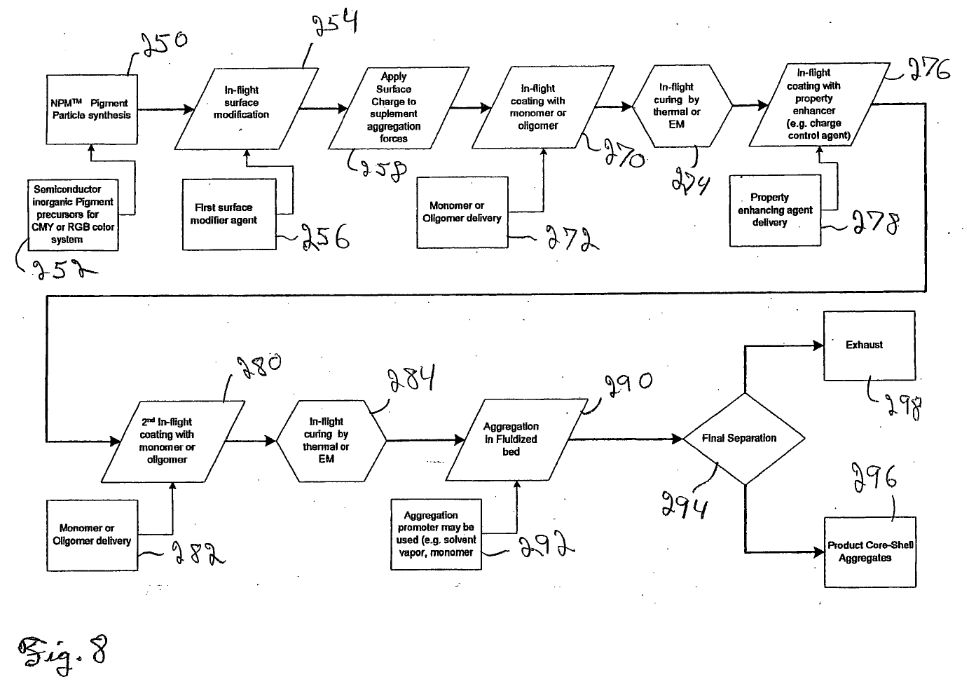

The general organization of the process is shown in the flow diagram of FIG. 6. The process is depicted with three milestones, formation of inorganic particles 132, collection of inorganic particles 134 and collection of dry composite particles 136. The transitions between the milestones involve optional in-flight processing 138 and optional post collection processing 140. These are both indicated as optional in the sense that all of the processing between milestones can be performed in-flight or all of the processing to form the composite can be performed following collection of the inorganic particles. If there is no in-flight processing 138, the transition between the formation of the inorganic particles and the collection of the inorganic particles simply involves collection, and if there is no post collection processing, the collection of the inorganic particles and the collection of the dry composite particles collapse into the same event.

As noted above, the formation of inorganic particles 132 can involve processes based on a reactive flow, such as laser pyrolysis and flame pyrolysis, or processes performed in solution, such as sol-gel condensation and miscelle/reverse miscelle approaches. For solution based processes, it may be desirable to collect the particles prior to performing further processing steps since the composition of the particles can be influenced by solvation effects. For example, it may be desirable to calcify with a heat treatment the particles produced by solution based method prior to further processing. However, if the particles have desired crystallinity and composition in solution following sysnthesis, the additional processing steps can be performed without harvesting the inorganic particles. In particular, a portion of the composite particle processing steps can be performed in the original inorganic particle synthesis solution prior to collecting the particles. For example, the inorganic particles in solution can be contacted with a linker compound and/or monomers/polymers prior to collecting the inorganic particles to pacify the surface of the particles.

In embodiments of particular interest, the inorganic particles are prepared in a reactive flow, for example, using flame pyrolysis or laser pyrolysis. These particles can be collected from the flow, or the particles can be modified using an in-flight process 138. For example, the particles can be flowed through a vapor and/or aerosol comprising a linker/surface modifier, such as those described above. The linker/surface modifier can condense onto the surface of the inorganic particles as they pass through the vapor/aerosol. The linker/surface modifier can be supplied continuously to present an effective steady state concentration such that the modification of the particles is consistent with corresponding uniform results. Similarly, the inorganic particles can be intersected with a vapor/aerosol comprising monomers and/or solvated polymers. The monomers can be subjected to heat and/or radiation, such as UV light, to induce polymerization following association with the inorganic particles. Similarly, a polymer can be crosslinked using heat and/or radiation, such as UV light, following association with the inorganic particles. Generally, these embodiments involving in-flight polymer association with the inorganic particles result in a composite with an architecture shown in FIG. 1.

The delivery of the linker/surface modifier can be performed at a selected location along the particle flow between the reaction zone at which the inorganic particles are formed and the particle collector. A plurality of modification stations can be used along this path. For example, at one location a linker can be added, at a second location a monomer is added and at a third location the flow is irradiated to polymerize the monomer. Similarly, other desirable combinations of in-flight processing steps can be used to form desired processed particles. In-flight processing of inorganic particles formed in a reactive flow are described further in copending U.S. patent application, which is being filed on the same day as the present application, Ser. No. 11/______ to Chiruvolu et al., entitled “In-Flight Modification of Inorganic Particles Within a Reactive Product Flow,” incorporated herein by reference.

At step 134, the inorganic particles are collected. The harvested inorganic particles can be unmodified inorganic particles, surface modified inorganic particles with associated linkers or other surface modifiers, or polymer-inorganic particle composite particles. If the inorganic particles are not the final composite particles, post-collection processing 140 can be performed. The dry composite particles are collected 136 after any post-collecting processing 140 of the inorganic particles.

Suitable processing of the inorganic particles can include, for example, solution-based processes, spray-drying processes or combinations thereof. Also, a plurality of processing steps can be used. Post collection processing generally comprises suspending the inorganic particles in a fluid, generally a liquid. The formation of the dispersion can involve, for example, the selection of an appropriate dispersant and vigorous mixing to well disperse the particles. Dispersing aids, such as surfactants and other functionalized surface modifying compositions, can be used to facilitate the dispersion. Suitable surface modifiers include, for example, linker compounds described above or linker compounds lacking a plurality of functional groups such that the compounds only bond with the particle surface. If a surface modifier was associated with the inorganic particles in-flight associated with the inorganic particle synthesis, generally no further surface modification would be used. It has been found that inorganic particles formed by laser pyrolysis generally have excellent dispersion capabilities under appropriate dispersion conditions. The dispersion and association with a linker compound with respect to inorganic particles formed using laser pyrolysis is described further in U.S. Pat. No. 6,599,631 to Kambe et al., entitled “Polymer-Inorganic Particle Composites,” incorporated herein by reference. Alternatively or additionally, the dispersed particles can be contacted with a polymer composition or monomers to form a composite forming suspension.

The dispersed inorganic particles with or without a surface modifier can be introduced into a processing step for introduction of polymer. The conditions and processing steps can be used to obtain desired particle architecture corresponding to the examples in FIGS. 1-5. For example, to get a layered structure as in FIG. 3, each layer can be applied sequentially in separate processing steps. Similarly, concentrations and processing conditions can be used to select between the architectures of FIGS. 1 and 2.

In some embodiments, the suspended inorganic particles can be subjected to emulsion polymerization. In emulsion polymerization, the polymer is formed in the presence of suspended inorganic particles with or without a surface modifier. For example, the polymerization can be based on a free radical mechanism. The polymers condense onto the suspended inorganic particles and may nor may not chemically bond to the inorganic particles or linkers on the surface of the inorganic particles. The concentrations and polymerization conditions can be controlled to select the polymer molecular weights and the relative amounts of polymer and inorganic particles as well as the composite particle size. In emulsion polymerization processes, generally the polymer precursors, the inorganic particles or both are in an organic solvent/dispersant and are added to an aqueous solution for the polymerization reaction. A commercial stirred reactor vessel can be adapted for these processes. After the composite particles are formed in the emulsion polymerization process, the composite particles can be collected and milled to form the collection of dry composite particles. Emulsion polymerization processes are described further in U.S. Pat. No. 6,946,229 to Suzuki et al., entitled “Toner For Forming Color Image, Image Forming Apparatus, And Toner Container,” incorporated herein by reference, and in U.S. Pat. No. 6,787,280 to Yamashita et al., entitled “Electrophotographic Toner And Method Of Producing Same,” incorporated herein by reference.

Additionally or alternatively, in some embodiments, a spray process is involved in the formation of the composite particles. The spray process can be a spray drying process or the like. In general, a dispersion is fed to an aerosol generator that directs an aerosol spray into a drying chamber. The temperature at the aerosol nozzle and/or within the drying chamber can be set to a value such that supplied heat evaporates the solvent/dispersant. For example, heated inert gas can be fed into the drying chamber to facilitate solvent/dispersant evaporation. Additionally or alternatively, the spray can be interacted with radiation within the drying chamber to initiate chemical reaction of compositions associates with the particles. For example, ultraviolet light can be used to initiate polymerization or crosslinking of polymer precursors within the composite particles. Similarly, for some polymer precursors, drying of the particles can induce polymerization and/or crosslinking reactions. Furthermore, the solvent/dispersant evaporation results in the formation of dry composite particles, which are collected from the apparatus. Commercial spray dryer apparatuses are available, such as Mobile Minor™ available from GEA Niro, Inc., Columbia, Md. Also, other spray drying apparatuses are available for facilitating the formation of unagglomerated particles, such as described in U.S. Pat. No. 6,962,006 to Chickering, III et al., entitled “Methods and Apparatus for Making Particles Using Spray Dryer and Inline Jet Mill,” incorporated herein by reference.

To improve the flowability and dispersability of the composite particles, the materials can be milled following their formation. A range of commercial mills can be adapted for this purpose. However, it may be desirable alternatively or additionally to form the particles using a process in which the surfaces of the particles do not significantly associate, especially with respect to hard fusing, such that the particles are inherently highly flowable. The surface pacification can be chemical or physical in nature. With respect to physical pacification, the particles can be formed, for example, in a spray dry approach such that the particles are in physical isolation when they are formed. Once the dry particles are collected, the dried polymer generally does not migrate to bind with the polymer of the neighboring particles if the polymer composition is appropriately selected with respect to composition. Furthermore, the chemical pacification can be performed by crosslinking the surface of the composite particles such that the surfaces of the particles do not mingle when the solvent is removed.

In other embodiments, inorganic particles are embedded on the surface of the composite particle. The polymer, optionally composite, particles can be combined with well dispersed inorganic particles. The polymer particles can comprise a composition with appropriate functional groups along the particle surface that forms chemical bonds with the inorganic particles or with a linker associated with the inorganic particles. Thus, the inorganic particles with or without a surface modifier can associate with the polymer particle surface due to non-bonding or bonding interactions. The various pacification approaches can be combined if desired.

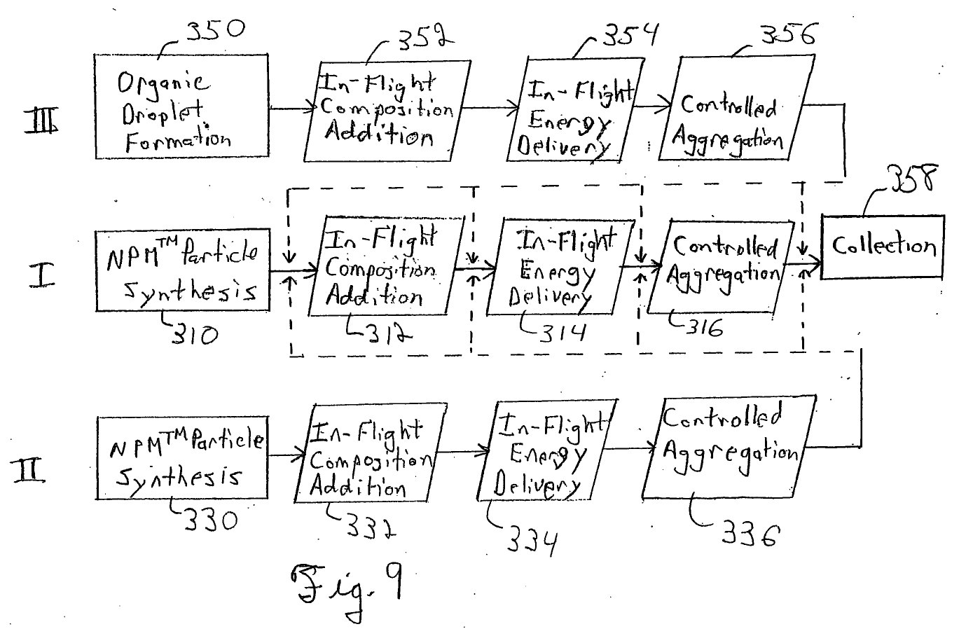

Further details for representative specific processes are described further with respect to FIGS. 7 and 8. FIG. 7 is directed to inorganic particle production in a reactive flow. Specifically, FIG. 7 refers to an NPM™ process, which is a commercial scale laser pyrolysis approach, such as covered under U.S. Pat. No. 5,958,348 to Bi et al., entitled “Efficient Production of Particles By Chemical Reaction,” incorporated herein by reference and other high throughput laser pyrolysis synthesis approaches, although other reactive flow based synthesis approaches can be substituted for the NPM™ process. The formation of inorganic particles is performed in the first step of alternative pathways A, B, and C. Pathways A, B and C provide alternative approaches for forming, optionally modifying and collecting inorganic particles. Pathways D and E are alternative approaches for completing the formation of the composite particles.

In pathway A, inorganic particles are synthesized by laser pyrolysis 200, and no additional in-flight processing is performed such that the inorganic particles are collected and incorporated into a process for the composite formation. The inorganic particles in this pathway can be selected to function as pigments, magnetic particles, charge modifying particles, fillers and/or to provide other desirable functionalities. For example, in some embodiments, the particles can be semi-conductor materials or phosphor particles. The collected particles are introduced into the D or E processing steps to associate the inorganic particles with a binder system.

In pathway B, an in-flight modification is performed on the inorganic particles. As specified in FIG. 7, the modification is a surface modification involving the coating with an organic pigment. In the in-flight process, inorganic particles are synthesized using laser pyrolysis 202. In parallel, an organic pigment is vaporized 204. The organic pigment vapor is contacted with the inorganic particle flow 206 to form coated inorganic particles through vapor condensation. The inorganic particles function as a substrate for the condensation of the organic pigment, and the inorganic particles function as a core of the resulting pigment particles. The pigment coated particles are collected for incorporation into processing steps D or E where they are associated with a binder.

In pathway C, the inorganic particles are synthesized with laser pyrolysis 208 and collected. There is no in-flight processing of the as-synthesized inorganic particles. However, in process C, the post-collection processing of the inorganic particles involves at least two separate steps. In this process, inorganic particles and pigment precursors are dispersed 210 together in a slurry. Then, pigment compositions are formed in the presence of the inorganic particles 212 such that they become associated with the inorganic particles upon formation. The precipitation of the pigment onto the inorganic particles can take place as a result of solvation effects, solvent removal, bonding to the inorganic particles or the like. In pathway C, the inorganic particles again serve as a substrate for pigment condensation, but in contrast with pathway B, the condensation in pathway C is performed from a dispersion. The formation of pigments in the presence of a silica, i.e., silicon dioxide, core is described further in U.S. Pat. No. 4,566,908 to Nakatani et al., entitled “Azoic Pigments Having a Silica Core,” incorporated herein by reference.

Following completion of the A, B or C process steps, the modified or unmodified inorganic particles are incorporated into the alternative composite forming steps of D and E. Both process D and process E involve a spray based approach. In the spray step of each process, a solution/dispersion is atomized using a suitable atomizer. Suitable atomizers include, for example, rotary atomizers that accelerate the liquid to a wheel edge using centrifugal forces, a two-fluid atomizers that uses kinetic energy from a gas stream to generate a shear force for atomization, and a pressure nozzle atomizer that generates a mechanical shear force at the orifice to atomize the droplets. Solvents/dispersants can be, for example, organic solvents, aqueous solvents or combinations thereof. In some embodiments, the solvent/dispersant or a portion thereof is recovered in the spray dry process. The spray generally is directed within a chamber. The composite particles are formed in-flight within the spray chamber, and the dry composite particles are collected from the chamber. The particles can be collected with a cyclone collector or a bag-type collection similar to bag collectors used for continuous recovery of laser pyrolysis generated particles. Process D and process E differ from each other with respect to the composition of the solution/dispersion sprayed and the in-flight processing of the spray.

In process D, the inorganic particles with or without surface modification are mixed 220 with oligomers and/or monomers as well as any other additives. The resulting solution/dispersion is sprayed 222, and the aerosol spray is subjected to polymerization conditions 224 within the spray chamber. Suitable polymerization conditions may be dependent on the composition of the oligomers/monomers. For example, the polymerization can be induced thermally with an appropriately heated chamber and/or with radiation, such as UV light and/or other energy source that induces the reaction. Generally, the polymer precursors have suitable functional groups for further polymerization and/or crosslinking. Similarly, the aerosol can be formed to combine a catalyst solution with the reaction solution when the aerosol is formed such that the catalyst induces the polymerization reaction. The composite particles are then collected 226 and can be used as desired.

In process E, the inorganic particle with or without surface modification are mixed 230 in a solution/dispersion with a dissolved polymer and any other additives. The resulting solution/dispersion is then sprayed 232 as an aerosol into the spray chamber. The evaporation of the solvent/dispersant within the spray chamber 234 results in desired composite particles, which are collected 236 to obtain a collection of the dry composite particles.

A fully in-flight processing approach is outlined in a flow diagram of FIG. 8. With respect to composite particle formation performed in-flight, inorganic nanoparticles are formed 250, for example, using NPM™ laser pyrolysis. Suitable precursors are delivered 252 to the inorganic particle production step. These inorganic particles can be, for example, pigment particles, such as semiconductor inorganic pigment particles. A series of in-flight processing steps are shown in FIG. 8. Generally, any particular step after synthesis of the inorganic particles 250 is optional, except for one monomer/oligomer delivery step. The inorganic particles can be contacted with a surface modifying agent 254 which are delivered from a source of a first surface modifying agent 256. A surface charge can be applied 258, for example, with a corona discharge, a charged beam, electrodes or the like. Depending on the particular circumstances, surface charge may be conducive to controlled aggregation or may inhibit undesirable aggregation. Thus, modification of surface charge can be used to control aggregation.

A monomer and/or oligomer can be delivered 270 to the flow. The monomers/oligomers are delivered 272 from a reservoir to the flow, such as using vapor deposition, aerosol deposition, combinations thereof or the like. The monomers/oligomers can be cured 274, i.e., polymerized and/or crosslinked, in-flight after being condensed onto the particles in the flow. In some embodiments, the polymerization is performed in the gas phase, as the vapor deposition process is taking place, while in other embodiments, the curing takes place in a condensed phase of droplets in the flow. The curing of an oligomer/polymer can involve evaporation of a solvent, but in other embodiments a reaction to cure the monomer/oligomer can be induced thermally, such as with infrared heating, or with radiation, such as ultraviolet light, other light, corona discharge, an electron beam, or the like or combinations thereof. For radiation induced curing, the radiation can be applied as a narrow beam or within a particular zone of the flow to control the reaction in a desired way to produce polymer with desired properties. Similar, to induce the curing process, a catalyst can be introduced to the flow in-flight at the time of the application of the monomer/oligomer or subsequently.

Referring to FIG. 8, a property enhancing agent can then be associated 276 with the particles in the flow. The property enhancing agent can be delivered from a reservoir 278. Suitable additives include, for example, wax, pigment or a charge control agent.

A second in-flight coating with a monomer and/or oligomer can be deposited 280 onto the particles in the flow. These additional polymeric materials may or may not form a separate layer in the final composite particles, such as shown in FIG. 3. Referring to FIG. 3, the second quantity of monomer/oligomer can be delivered 282 from a reservoir of second monomer/oligomer compositions, which may be the same or different from the first quantity of monomer/oligomer compositions delivered at step 270. The second quantity of monomers/oligomers can be cured in-flight 284. This can be performed using heat, appropriate radiation or the like as described above with respect to step 274. In additional embodiments, further additives and/or additional coatings of monomer/oligomer can be added subsequent to step 280, as desired.

If desired, controlled aggregation can be performed prior to final collection, although controlled aggregation can similarly be performed after collection and storage with a continuous or batch design. In an embodiment of an in-flight approach, the flow is modified to increase the density of the flow to effectively form a fluidized bed, or directed into a fluidized bed reactor structure, to induce controlled agglomeration 290. An aggregation promoter such as a solvent, vapor, crosslinking agent, monomer or the like can be added 292 to the fluidized bed reactor to promote controlled aggregation of the composite particles from the flow. The conditions, such as the addition of heat and/or an aggregation promoter, in the fluidized bed portion of the flow can be adjusted to yield desired aggregation. Fuidized bed reactors generally involve suspension of particles in a fluid for supplying controlled reaction conditions. Controlled reactions in fluidized bed reactors are described further, for example, in U.S. Patent Application Publication Number 2005/0267269A to Hagerty et al., entitled Polymerization Process,” and U.S. Pat. No. 4,548,138 to Korenberg, entitled “Fast Fluidized Bed Reactor and Method of Operating the Reactor,” both of which are incorporated herein by reference. The product composite particles are separated 294 from the flow in the fluidized bed reactor to separate the resulting aggregates 296 from the waste exhaust 298. Final separation of the product can involve, for example, filtration or other suitable approaches. High volume particle collectors are described further, for example, in U.S. Pat. No. 6,270,732 to Gardner et al., entitled “Particle Collection Apparatus And Associated Methods,” incorporated herein by reference. The exhaust can be scrubbed as appropriate to remove toxic or environmentally damaging materials and to meet appropriate regulatory standards.

In additional embodiments, the order of the processing steps in FIG. 8 may be modified, particular steps can be repeated and other steps can be added, as appropriate. Also, additional monomer/oligomer coating layers can be added with or without additional additive composition(s). Additional additive(s) can be added at various points in the process.

As noted above, in some embodiments, a plurality of inorganic particles can be formed independently and combined in-flight. Also, as noted above, non-mineral droplets can be formed in-flight for subsequent processing into composites. A general diagram is shown in FIG. 9 broadly indicating optional approaches for in-flight processing with a plurality of inorganic particle channels and a non-mineral droplet processing channel. Herein, the description of non-mineral processing includes, for example, organic processing as well as silicon-based composition processing, and/or surface modification composition processing. Non-mineral droplet processing is in contrast with the inorganic particle processing in which the inorganic particles can be ceramic and generally have a mineral like composition. Generally, the non-mineral droplets are deformable such that they can coat or envelope the inorganic particles.

Referring to FIG. 9, Channels I and II are inorganic particle production and processing channels, and Channel III is an organic droplet/particle production and processing channel. Channels II and III are optional, and additional inorganic processing channels and/or organic processing channels can be added as appropriate. In general, inorganic processing channels I and II can involve processing steps as shown in FIG. 8 with particular steps added or removed as desired. As shown in FIG. 9, the processing steps are shown more succinctly with steps shown as addition of compositions, delivery of energy or controlled aggregation.

Channel I comprises inorganic particle synthesis 310 with optional modification. In-flight composition addition 312 can comprise addition of monomers/oligomers and/or the addition of other additives, such as organic pigments, surface modifiers, wax, charge control agents or the like or combinations thereof. In-flight energy delivery 314 can involve energy delivery for curing, and/or the addition of surface charge and/or the like. Similarly, controlled aggregation 316 can involve application of surface charge, altering flow density and/or the like. These processing steps can be omitted or repeated as appropriate, and the order of these processing steps can be selected as desired. Channel II similarly comprises inorganic particle synthesis 330, optional in-flight composition addition 332, optional in-flight energy delivery 334 and optional controlled aggregation 336.

Non-mineral processing channel III generally can be initiated with droplet formation 350. Techniques have been developed to form well collimated and entrained aerosol flows. See, for example, U.S. Pat. No. 6,193,936 to Gardner et al., entitled “Reactant Delivery Apparatuses,” incorporated herein by reference, which can be adapted for flows without inorganic precursors. Initial droplets can comprise polymer/monomers/oligomers, solvent and/or other organic or silicon-based composition(s), such as pigments or property modifiers. Once the initial droplets are formed, one or more additional processing steps can be performed, as desired. For example, one or more additional compositions can be added 352 to the flowing droplets, for example, using vapor deposition and/or aerosol deposition. Similarly, one or more steps involving the addition of energy/radiation 354, such as a corona discharge, infrared light, ultraviolet light, or the like, or combinations thereof. Furthermore, controlled aggregation can be performed 356, such as through modifications in the flow and/or through adjustments in the surface charges of the droplets. These processing steps can be omitted or repeated as appropriate, and the order of these processing steps can be selected as desired.

Flows from channels II, III or others can be combined with the flow from channel I. For example, with respect to combining multiple inorganic particles in the composite particles, it may be desired, for example, to combine an inorganic semiconductor pigment with a magnetic inorganic particle. Use of surface exposed magnetic iron oxide particles for toner production is described further, for example in U.S. Pat. No. 6,875,549 to Yamazaki et al., entitled “Dry Toner Production Process, Image Formation Method and Process Cartridge,” incorporated herein by reference. Each flow from channels II or III can be combined with the flow in channel I independently at one or more selected stages in the channel I processing. This is indicated schematically with dashed lines in FIG. 9. However, of course, the processing steps themselves in channel I of FIG. 9 can have fewer steps, additional steps, a different order, etc., such that schematic depiction in FIG. 9 for alternative combining orders for the different channels are only a representative sampling of the possibilities. To combine the flows, in some embodiments, the flows can be directed to intersect along a common conduit, although alternative approaches for combining the flows can be used. For these various embodiments, the composite particles are ultimately collected 358, for example, using one of the various collectors described herein.

Apparatuses for performing in-flight processing, an example of in-flight surface modification of inorganic particles formed with laser pyrolysis and further details on in-flight processing of composites material are described in copending U.S. patent application filed on the same day as the present application with Ser. No. 11/______ to Chiruvolu et al., entitled “In-Flight Modification of Inorganic Particles Within a Reaction Product Flow,” incorporated herein by reference.

Uses and Structures Formed from the Composite Particles

The composite particles can be used essentially in any application in which the properties of the composite particles are advantageous. In particular, the small composite particles are suitable for forming coatings and for printing applications. As noted above, the small size of the composite particles provides improved performance as toner since sharper images can be formed, and generally the images can be formed at lower temperatures due to the smaller particle sizes. Toner particles can be printed, for example, using established electrophotographic processes. In addition, the small size of the composite particles can be advantageous for forming thin coatings.

For the formation of thin coatings, in some embodiments, the composite particles can be suspended in a dispersant and coated onto a substrate surface using, for example, spray coating, spin coating, dip coating, extrusion or other suitable coating approach. The spray coating can be performed to provide a desired thickness of the composite particles upon the removal of the dispersant. For example, roughly a monolayer equivalent of composite particles can be deposited uniformly over a substrate, although thicker layers can be similarly formed as desired. The amount of composite material can be controlled through the adjustment of the concentration of the dispersion and the spray conditions. After depositing the composite particle coating, the coating can be heated to flow the polymer within the composite particles. The flow can result in a layer of composite material in contrast with a layer of distinguishable particles. Through this approach, very thin layers of polymer-inorganic particle composite material can be deposited. In some embodiments, the layer can have an average thickness of no more than about five microns, in other embodiments, no more than about a micron, in some embodiments no more than about 500 nm and in further embodiments from about 5 nm to about 250 nm. A person of ordinary skill in the art will recognize that additional ranges of average coating thicknesses within the explicit ranges above are contemplated and are within the present disclosure.

The composite particles can be printed onto a substrate to form images on the substrate. To form images, generally the coating is applied to selected portion of the substrate less than the entire substrate surface. The printed material can form characters or other desired images. The image can be black and/or desired colors. In some embodiments, the images where applied, have an average thickness of no more than about 3 microns and in further embodiments no more than about 2 microns. A person of ordinary skill in the art will recognize that additional ranges within the explicit ranges of average image thickness are contemplated and are within the present disclosure. To set the image, the coated substrate can be heated above the flow temperature of the polymer within the composite particles.

Coatings of various thicknesses whether or not subsequently heated can be useful for a range of applications, such as optical applications, protective coatings, electromagnetic shielding and thermal conduction. With respect to optical coatings, the index of refraction of the composite can be selected to yield desirable properties for antireflective coatings, UV absorbing coatings, optical filters and the like. Protective coatings can be used if the composite is a hard material that can protect a softer substrate. Electromagnetic shielding coatings can be formed with magnetic inorganic particles, such as iron oxides or iron carbides, as described further in U.S. Pat. No. 5,938,979 to Kambe et al., entitled “Electromagnetic Shielding,” incorporated herein by reference. Good thermal conducting coatings can be formed with aluminum nitride (AlN) particles, which is a very good thermal conductor.

The composite particles described herein are well suited for a range of printing applications. For example, the composite particles can be directly used as dry toner for electrophotographic printing. Dry toners are used in laser printers, photocopiers, fax machines, combinations thereof and the like. Similarly, the composite particles can be dispersed in a liquid for use as a liquid toner. Liquid toner compositions can be substituted for dry toners for electrophotographic printing. The use of liquid toners with solid toner particles is described further, for example, in U.S. Pat. No. 6,132,922 to Fukae et al., entitled “Liquid Developer For Electrophotographic Printing Apparatus,” incorporated herein by reference.

The composite particles can also be incorporated into inks for ink jet printing, lithographic printing, gravure printing, screen printing and the like. The composite particles can function as pigments and/or property modifiers to facilitate the formation of a stable image. Due to the small particle size, sharper images can be formed with less material. The use of printing inks with particulate colorants for newspaper publishing is described in U.S. Pat. No. 5,981,625 to Zou et al., entitled “Non-Rub Off Printing Inks,” incorporated herein by reference.

The embodiments above are intended to be illustrative and not limiting. Additional embodiments are within the claims. In addition, although the present invention has been described with reference to particular embodiments, those skilled in the art will recognize that changes can be made in form and detail without departing from the spirit and scope of the invention. Any incorporation by reference of documents above is limited such that no subject matter is incorporated that is contrary to the explicit disclosure herein.

What is claimed is:

1. A collection of composite particles having an average particle size of no more than about 2.5 microns, wherein each of at least about 95 percent of the composite particles comprise a thermoplastic polymer binder and a plurality of inorganic particles.

2. The collection of composite particles of claim 1 wherein the composite particles comprise a surface modifier chemically bonded to the surface of the inorganic particles.

3. The collection of composite particles of claim 1 wherein the composite particles further comprise a pigment, a phosphor or a dye.

4. The collection of composite particles of claim 1 wherein the composite particles further comprise a charge modulator.

5. The collection of composite particles of claim 1 wherein the composite particles comprise a magnetic inorganic particle.

6. The collection of composite particles of claim 1 wherein a majority of the particles comprise a plurality of layers having distinct compositions from each other.

7. The collection of composite particles of claim 1 wherein a majority of composite particles comprise a plurality of inorganic particles embedded along the surface of the composite particles.

8. A collection of composite particles comprising inorganic particles and a coating comprising an organic or silicon-based compound, wherein the composite particles have an average particle size of no more than about 10 microns, wherein the inorganic particles have an average particle size of no more than about 100 nanometers and wherein the inorganic particles are phosphors, metal nitrides, metal carbides, metal sulfides, metalloid nitrides, metalloid carbides, metalloid sulfides, doped particles, combinations thereof or mixtures thereof.

9. The collection of composite particles of claim 8 wherein the inorganic particles comprise a phosphor with a host crystalline lattice and an activator dopant.

10. The collection of composite particles of claim 8 wherein the coating comprises a surface modifier chemically bonded to the inorganic particles.

11. The collection of composite particles of claim 8 wherein the coating comprises a thermoplastic polymer binder.

12. A collection of composite particles having a layered structure having distinct compositions from each other, the composite particles comprising inorganic particles and a thermoplastic polymer binder, wherein the composite particles have an average particle size of no more than about 10 microns and wherein each layer of the composite particles comprises a polymer.

13. The collection of composite particles of claim 12 wherein a first layer of the composite particles comprises first inorganic particles and the thermoplastic polymer binder and a second layer comprises second inorganic particles different from the first inorganic particles and a polymer.

14. The collection of composite particles of claim 12 wherein an outer layer of the composite particles comprise crosslinked polymer.

15. A method for forming composite particles comprising a composite of inorganic particles and a polymer, the method comprising spray drying a solution comprising the inorganic particles and a polymer precursor wherein the spray is reacted in-flight to form a thermoplastic polymer binder.

16. The method of claim 15 wherein the in-flight reaction is initiated through irradiation with electromagnetic radiation.

17. The method of claim 16 wherein the electromagnetic radiation comprises ultraviolet light.

18. The method of claim 15 wherein the in-flight reaction is initiated thermally.

19. The method of claim 15 wherein the composite particles are substantially dispersible with an average particle size of no more than about 2.5 microns.
